(19) United States
(12) Patent Application Publication
(10) Pub. No.: US 2026/0044882 A1
(43) Pub. Date: Feb. 12, 2026

(54) GENERATING A FIXED VALUE FOR A RECURRING VALUE LOCK ACROSS GRAPHICAL USER INTERFACES OF COMPUTING DEVICES

(71) Applicant: Lyft, Inc., San Francisco, CA (US)

(72) Inventors: Yahui Jin, San Francisco, CA (US); Zhu Zhang, San Francisco, CA (US); Xabier Azagirre Lekuona, New York, NY (US); Morgan Mackenzie Kidd, San Francisco, CA (US); Suwei Luo, Fremont, CA (US); Raquel Lorena Perez Rioja, San Francisco, CA (US); Zhaohan Sun, Toronto (CA)

(21) Appl. No.: 19/292,764

(22) Filed: Aug. 6, 2025

Related U.S. Application Data
(60) Provisional application No. 63/680,462, filed on Aug. 7, 2024.

(51) Int. Cl. G06Q 30/0283; G01C 21/34; G06Q 30/0207; G06Q 30/0235; G06Q 50/43

(52) U.S. Cl. CPC G06Q 30/0284; G01C 21/3438; G01C 21/3484; G06Q 30/0224; G06Q 30/0235; G06Q 50/43

(57) ABSTRACT

The present disclosure relates to systems, non-transitory computer-readable media, and methods for generating a fixed value for a recurring value lock and providing elements to apply the recurring value lock within a graphical user interface on a computing device. In particular, in one or more embodiments, the disclosed systems generate the fixed value based on a location information and a recurring window, then provide the fixed value, a time duration for which the recurring value lock is valid, and an upfront value for the recurring value lock on the computing device. In addition, the disclosed systems provide elements to apply a recurring value lock to a request for a transportation service. Moreover, in one or more embodiments, the disclosed systems provide graphical user interfaces for generating and managing recurring value locks.

### CROSS-REFERENCE TO RELATED APPLICATIONS

This application claims priority to and the benefit of U.S. Provisional Patent Application No. 63/680,462, filed on Aug. 7, 2024, which is incorporated herein by reference in its entirety.

### BACKGROUND

Recent years have seen significant improvements in conventional transportation systems that utilize mobile devices to coordinate across computer networks. Indeed, the proliferation of web and mobile applications has enabled requesting devices to utilize on-demand ride sharing systems to identify matches between computing devices (e.g., provider devices and requester devices) and coordinate across computer networks to initiate transportation from one geographic location to another. For instance, conventional transportation systems can determine the geographic locations of computing devices, generate digital matches between computing devices, and further track, analyze, and manage pick-up, transportation, and drop-off routines through digital transmissions across computer networks. Despite these recent advances, however, conventional transportation systems continue to exhibit a number of drawbacks and deficiencies, particularly with regard to the efficiency and flexibility of implementing computer systems of conventional transportation systems and the number of user interface interactions required to utilize transportation matching services on a recurring basis.

For example, conventional transportation systems suffer from significant inefficiency problems with regard to serial queries for generating transportation matches. Conventional transportation systems utilize variable values for transportation services based on real-time availability at the time of a query by a computing device. Because of this variability, computing devices will often close out an application (e.g., a transportation system application) and re-initiate the application in an attempt to query the transportation system and obtain a different value for a request for a transportation service. Alternatively, computing devices will often navigate to alternative websites or applications to query for a different transportation match and corresponding value. However, these serial submissions utilize significant computer resources to iteratively manage transportation matches, process cancellation requests, and reassign requests across multiple provider devices, leading to an inordinate use of computing resources (e.g., memory and processing power), excessive bandwidth utilization, and increased latency.

Conventional systems are also often inflexible, inaccurate, and inefficient in generating transportation matches based on available data across a transportation network of computing devices (e.g., provider devices and requester devices). For example, for each submission, conventional transportation systems identify computing devices available for to provide transportation services and generate prospective matches between computing devices based on available and forecasted information. However, available and forecasted information is often inaccurate and/or unavailable, leading to transportation matches that are inefficient. This leads to overall network inefficiency as inefficient matches between computing devices lead to additional queries between client devices, bandwidth utilization, and interactions.

In addition, conventional transportation systems require excessive user interface interactions for computing devices that routinely submit transportation requests. For example, some computing devices utilize conventional transportation systems for commuting and must submit a new transportation request for each ride, inputting starting and destination locations for each request for a transportation service. Moreover, submitting a request requires users to navigate through multiple graphical user interfaces to provide the required input to initiate and generate the request. Indeed, a user who utilizes transportation system must navigate through these interfaces each time, even if they utilize the same ride around the same time. These, along with additional problems and issues, exist with regard to conventional transportation systems.

### BRIEF SUMMARY

Embodiments of the present disclosure provide benefits and/or solve one or more of the foregoing or other problems in the art with systems, non-transitory computer-readable media, and methods for intelligently implementing a recurring value lock across graphical user interfaces of computing devices. In particular, in one or more embodiments, the disclosed systems generate a locked-in value based on location information and a time window for a recurring ride and provide, within a graphical user interface on the computing device, the fixed value for the recurring ride and a time duration for which the locked-in value is valid. Upon receiving an acceptance for the recurring ride and the locked-in value, the disclosed systems provide elements to apply the locked-in value to a transportation request for the locations associated with the recurring ride. In addition, in one or more embodiments, the disclosed systems provide a notification of an upfront value generating the recurring ride. Further, in one or more embodiments, the disclosed systems provide graphical user interfaces for generating and managing recurring rides associated with the computing device. Additional features and advantages of one or more embodiments of the present disclosure are outlined in the description that follows, which will, in part, be obvious from the description or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a recurring value lock generation system can operate in accordance with one or more embodiments.

FIG. 2 illustrates an overview of a recurring value lock generation system providing options to generate a recurring value lock and generating elements to apply the transportation value lock in accordance with one or more embodiments.

FIG. 3 illustrates a schematic diagram of a recurring value lock generation system monitoring a computing device and providing information to generate a recurring value lock and updating a recurring value lock in accordance with one or more embodiments.

FIGS. 4A-4C illustrate an exemplary series of graphical user interfaces of the recurring value lock generation system providing an option to generate a recurring value lock in accordance with one or more embodiments.

FIGS. 5A-5C illustrate an exemplary series of graphical user interfaces of the recurring value lock generation system providing elements to generate a recurring value lock in accordance with one or more embodiments.

FIGS. 6A-6C illustrate an exemplary series of graphical user interfaces of the recurring value lock generation system providing an element to apply a recurring value lock to a transportation request in accordance with one or more embodiments.

FIGS. 7A-7B illustrate an exemplary series of graphical user interfaces of the recurring value lock generation system providing a selectable option to generate a transportation request applying a transportation value lock and a corresponding transportation match in accordance with one or more embodiments.

FIGS. 8A-8B illustrate example recurring value lock management interfaces for managing recurring value locks associated with a computing device in accordance with one or more embodiments.

FIG. 9 illustrates a flowchart of a series of acts for generating a fixed value for a recurring value lock and providing an element to apply the recurring value lock in accordance with one or more embodiments.

FIG. 10 illustrates a block diagram of a computing device for implementing one or more embodiments of the present disclosure.

FIG. 11 illustrates an example environment for a transportation matching system in accordance with one or more embodiments.

### DETAILED DESCRIPTION

This disclosure describes one or more embodiments of a recurring value lock generation system that intelligently implements a recurring value lock across graphical user interfaces of computing devices. Specifically, in one or more embodiments, the recurring value lock generation system generates a locked-in value by generating a fixed value based on identifying a starting location, a destination location, and a time window for a recurring ride from a graphical user interface on a computing device. The recurring value lock generation system then provides the fixed value, a time duration for the fixed value, an option to accept the recurring ride, and, in some cases, a notification of an upfront value for generating the recurring ride. In response to user interaction with the option to accept the recurring ride for the fixed value, the recurring value lock generation system provides elements to apply the recurring ride to a transportation request initiated during the time window and from the starting location to the destination location.

As mentioned, the recurring value lock generation system generates a fixed value for a recurring ride. In particular, the recurring value lock generation system generates a fixed value for transportation requests received within the time window and from the starting location to the destination location. In one or more embodiments, the recurring value lock generation system utilizes a forecasting model to generate the fixed value using recurring historical transportation values associated with the computing device, such as location-time combinations corresponding to the starting location, the destination location, and the recurring window.

Moreover, as mentioned, in one or more embodiments the recurring value lock generation system generates a fixed value based on the starting location, destination location, and time window for a recurring ride. In particular, the recurring value lock generation system provides an option to generate a recurring value lock for a recurring ride by providing a starting location element, a destination location element, and a recurring time lock window element within the graphical user interface of a computing device. In one or more embodiments, the recurring value lock generation system provides the option to generate a recurring value lock after monitoring transportation requests and requester features from the computing device and determining a recurring transportation pattern indicating that the computing device repeatedly requests rides from a first location (e.g., the starting location) to a second location (e.g., the destination location) within a window of time.

In addition, in one or more embodiments, the recurring value lock generation system can generate multiple recurring value locks for a computing device. In one or more embodiments, the recurring value lock generation system provides a recurring value lock management user interface to manage the recurring value lock. In particular, the recurring value lock generation system provides for display indications of recurring value locks and the fixed value corresponding to the computing device, along with options to manage the recurring value locks.

As mentioned, in one or more embodiments, the recurring value lock generation system provides elements to apply the recurring value lock. For example, the recurring value lock generation system provides a transportation request element (e.g., within a list of transportation request elements) to initiate a transportation request from the starting location to the destination location and a notification that the transportation request utilizes the fixed value. As another example, the recurring value lock generation system identifies initiation of a transportation application session via the computing device, while the computing device is located at the starting location and during the recurring window and provides a selectable option to generate a transportation request applying the recurring value lock. Moreover, based on receiving a user selection of the selectable option to generate the transportation request, the recurring value lock generation system generates a transportation match with a computing device according to the fixed value.

The recurring value lock generation system provides a variety of technical advantages relative to conventional transportation systems. For example, the recurring value lock generation system improves efficiency relative to conventional transportation systems. Specifically, by generating a fixed value and utilizing the fixed value to generate a predictable value for a transportation request, the recurring value lock generation system alleviates the need for serial submissions in order to obtain a lower value for a transportation request. In addition, the recurring value lock generation system can reduce navigation to alternate websites or transportation applications as computing devices seek to manage variable values over time for transportation requests for the same starting and destination locations. Moreover, the recurring value lock generation system can generate additional transportation request elements and corresponding additional values, which may be lower than the fixed value, further reducing the need for serial submissions to obtain a lower value for a transportation request. Indeed, by reducing serial submissions or navigation to alternate applications, the recurring value lock generation system can reduce the significant computing resources that conventional transportation systems utilize to iteratively generate transportation matches, process cancellation requests, execute multiple applications, and reassign requests across multiple provider devices.

In addition, the recurring value lock generation system improves flexibility, accuracy, and efficiency in generating transportation matches utilizing implementing computing systems. Indeed, by generating and implementing transportation value locks, the recurring value lock generation system can access significantly more accurate forecasted measures for computing devices at any particular time, transmit digital notifications to provider devices to come online, and generate more efficient transportation matches to satisfy the anticipated computing device queries. Thus, the recurring value lock generation system can more reliably and flexibly generate transportation matches between computing devices.

Moreover, the recurring value lock generation system reduces the amount of user interface interactions compared to conventional transportation systems. Specifically, the recurring value lock generation system provides elements to apply recurring value locks to transportation requests for computing devices that utilize transportation matching services for commuting. For example, the recurring value lock generation system determines that the computing device is located at the starting location for a recurring value lock during the recurring window and provides elements to select the transportation value lock when generating the transportation request. Moreover, when the computing device initiates a transportation matching application when located at the starting location during the recurring window, the recurring value lock generation system can provide an option on the home screen of the transportation matching application to generate a transportation request. Indeed, the recurring value lock generation system can generate the transportation request using the fixed value and transportation match with a provider device with a single user interaction, unlike conventional transportation systems that require navigating through multiple interfaces and requiring user input on each interface.

As illustrated by the foregoing discussion, the present disclosure utilizes a variety of terms to describe features and advantages of the recurring value lock generation system. Additional detail is now provided regarding the meaning of such terms. For example, as used herein, the term “recurring value lock” (or “recurring value lock”) refers to a set value for a recurring transportation service. In particular, the term “recurring value lock” can include an agreement or feature that ensures a fixed value for a transportation request from a first location to a second location during a window of time. For example, a recurring value lock can include a value (e.g., monetary amount/price) for a transportation request within a transportation matching system from a predetermined starting location to a predetermined destination location when the transportation request is submitted during a window of time (e.g., 8 a.m.-9 a.m.).

Moreover, as used herein, the term “fixed value” refers to a set monetary amount for a recurring value lock. In particular, the term “fixed value” indicates a monetary amount for a transportation request received from a computing device indicating the starting location and destination location of the recurring value lock and received during a recurring window of the recurring value lock. For example, a fixed value can refer to a monetary amount in a currency local to where the computing device is located.

Also, as used herein, the term “request” refers to a request from a computing device (i.e., a requester device) for transport by a transportation vehicle. In particular, a “request” or “transportation request” includes a request for a transportation vehicle to transport a requester or a group of individuals from one geographic area to another geographic area. A request can include information such as a starting location (or pick-up location), a destination location (e.g., a drop-off location, a location to which the requester wishes to travel), a request location (e.g., a location from which the transportation request is initiated), location profile information, a requester rating, or a travel history. As an example of such information, a request may include an address as a destination location and the requester's current location as the destination location. A request can also include a computing device initiating a session via a transportation matching application and transmitting a current location (thus indicating a desire to receive transportation services from the current location).

In addition, as used herein, the term “recurring window” (or “recurring window”) refers to a set period (e.g., time of day) for a recurring value lock. In particular, the term “recurring window” refers to a predetermined time period during which when a transportation matching system receives a transportation request from a computing device associated with a recurring value lock, the transportation matching system will utilize the fixed value for the request. For example, a recurring window can be a time period that a computing device receives as user input when generating a recurring transportation value request. To illustrate, a recurring window can be a set one-hour time period during a twenty-four-hour time period, such as 8 a.m. to 9 a.m.

Further, as used herein, the term “time duration” refers to a period of time during which a fixed value for a recurring value lock is valid. Specifically, the term “time duration” refers to a period of hours, days, weeks, or months during which a request submitted by a computing device corresponding to a recurring value lock and from the starting location to the destination location indicated in the recurring value lock, will utilize the fixed value for the request. To illustrate, a time duration can be thirty days from the date a recurring value lock is generated.

As used herein, the term “upfront value” refers to a monetary amount applied to a user account to generate a recurring value lock. In particular, the term “upfront value” indicates a monetary amount that, when satisfied, will provide the opportunity to access recurring value lock. For example, by providing user input to generate a recurring value lock, a transportation matching system will charge the computing device (or a user account associated with the computing device) the upfront value.

In addition, as used herein, the term “marginal requester value” refers to a monetary amount incurred by a computing device by utilizing the recurring value lock. In particular, the term “marginal requester value” refers to the monetary amount of the difference between requests utilizing the fixed value and a monetary amount for a request submitted without using the recurring value lock. For example, a marginal requester value can refer to the monetary value saved by using the transportation value lock rather than submitting a request at the same time.

Moreover, as used herein, the term “value threshold” refers to a level or threshold for a marginal requester value at which a recurring value lock generation system will terminate a recurring value lock. In particular, the term “value threshold” refers to a cap, level, or trigger of a monetary amount of the marginal requester value that will trigger the termination of a recurring value lock. To illustrate, a value lock can refer to a set monetary value, such as $40.

As suggested above, the term “computing device” refers to a device associated with a transportation matching system. For instance, a computing device can receive interaction from a requester in the form of user interaction to submit a request for a transportation service. After the transportation matching system matches a computing device (e.g., a requester computing device) with an additional computing device (e.g., a provider computing device), the requester can await pickup by the provider at a predetermined starting location (or pick-up location). Upon pick-up, the provider transports the requester to a drop-off location specified in the request for the transportation service. Accordingly, a requester may refer to (i) a person who requests a request or other form of transportation but who is still waiting for pickup, (ii) a person who requests a request or other form of transportation for another person, or (iii) a person whom a transportation vehicle has picked up and who is currently riding within the transportation vehicle to a drop-off location. In addition, the term “computing device” can also refer to a device associated with a transportation provider or driver (e.g., a human driver or an autonomous computer system driver) that operates a transportation vehicle. For instance, “provider computing device” refers to a mobile device such as a smartphone or tablet operated by a provider—or a device associated with an autonomous vehicle that drives along transportation routes.

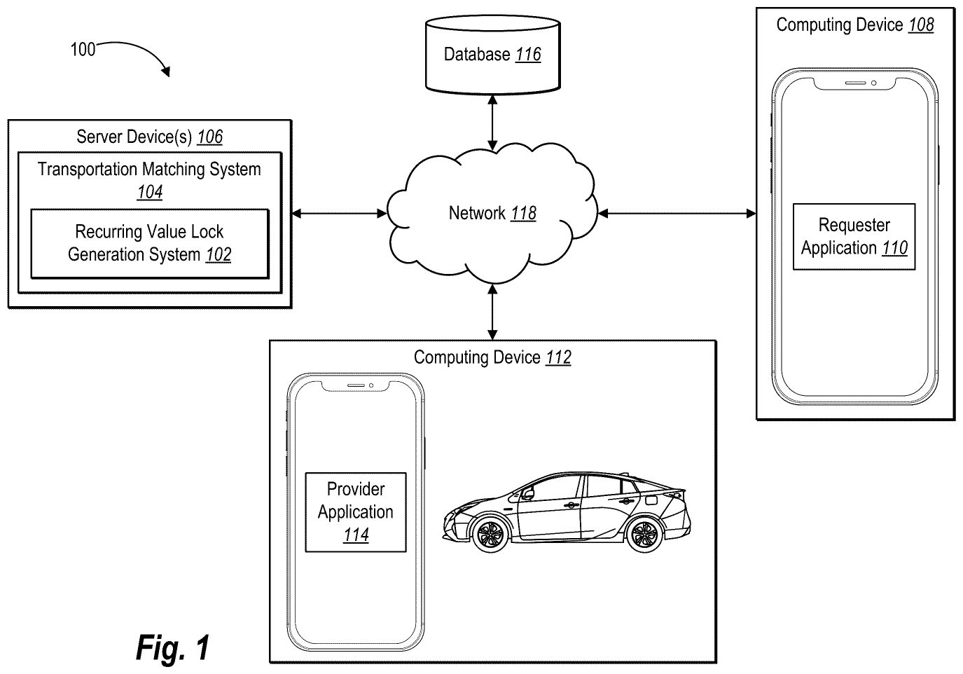

Additional details regarding the recurring value lock generation system will now be provided with reference to the figures. For example, FIG. 1 illustrates a block diagram of a system environment for implementing a recurring value lock generation system in accordance with one or more embodiments. An overview of the recurring value lock generation system 102 is described in relation to FIG. 1. Thereafter, a more detailed description of the components and processes of the recurring value lock generation system 102 is provided in relation to the subsequent figures.

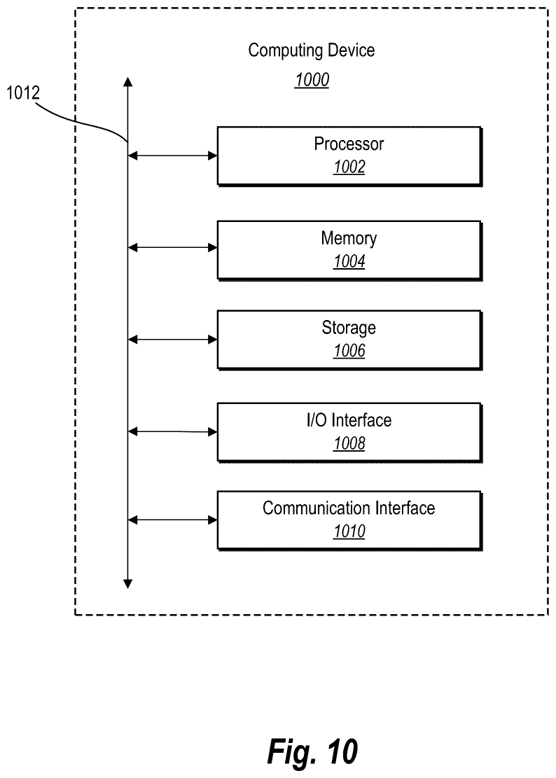

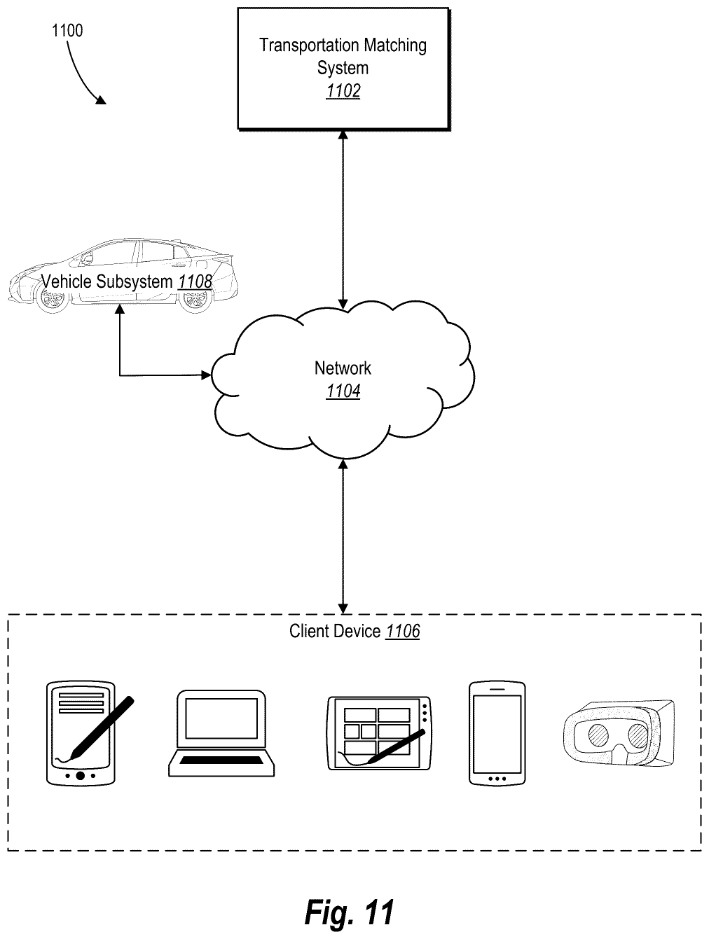

As shown in FIG. 1, environment 100 includes server device(s) 106 housing the recurring value lock generation system 102 as part of the transportation matching system 104. The environment of FIG. 1 further includes a computing device 108 (including a requester application 110), a computing device 112 (including a provider application 114), a database 116, and a network 118. The server device(s) 106 can include one or more computing devices to implement the recurring value lock generation system 102. Additional detail regarding the illustrated computing devices (e.g., the server device(s) 106, the computing device 108, and/or the computing device 112) is provided with respect to FIGS. 10-11 below.

As shown, the recurring value lock generation system 102 utilizes network 118 to communicate with the computing device 108, the computing device 112, and the database 116. The network may comprise any network described in relation to FIGS. 10-11. For example, the recurring value lock generation system 102 communicates with the computing device 108 and the computing device 112 to match requests (e.g., transportation requests) received from the computing device 108 with the computing device 112. Indeed, the transportation matching system 104 or the recurring value lock generation system 102 can receive a request from the computing device 108 and can provide request information to various provider devices, such as a requested location (e.g., a requested starting location and/or a requested drop-off location), an associated event (e.g., a future event), and a requester identification (e.g., for a requester corresponding to computing device 108). In some embodiments, per device settings, the transportation matching system 104 or the recurring value lock generation system 102 receives device information from various provider devices and the computing device 108, such as location coordinates (e.g., latitude, longitude, and/or elevation), orientations or directions, motion information, and indications of user interactions with various interface elements.

To facilitate connecting requests with transportation vehicles, in some embodiments, the transportation matching system 104 or the recurring value lock generation system 102 communicates with the computing device 112 and other computing devices (e.g., provider computing devices, through a provider application 114). As indicated by FIG. 1, the computing device 112 includes the provider application 114. In many embodiments, the transportation matching system 104 or the recurring value lock generation system 102 communicates with the computing device 112 through the provider application 114 to, for example, receive and provide information including location data, motion data, request information (e.g., starting locations and/or destination locations), and transportation route information for navigating to one or more designated locations.

Similarly, the transportation matching system 104 or the recurring value lock generation system 102 communicates with the computing device 108 (e.g., through the requester application 110) to facilitate connecting requests with transportation vehicles. In many embodiments, the recurring value lock generation system 102 communicates with the computing device 108 through the requester application 110 to, for example, receive and provide information including location data, motion data, request information (e.g., requested locations), and navigation information to guide a requester to a designated location.

As indicated above, the transportation matching system 104 or the recurring value lock generation system 102 can provide (and/or cause the computing device 112 to display or render) visual elements within a graphical user interface associated with the provider application 114 and the requester application 110. For example, the transportation matching system 104 or the recurring value lock generation system 102 can provide a digital map for display on the computing device 112 that illustrates a transportation route to navigate to a designated location. The recurring value lock generation system 102 can also provide a request notification for display on the computing device 112 indicating a request.

Moreover, as illustrated, the recurring value lock generation system 102 provides a user interface via the computing device 108 that includes various selectable options. For example, the recurring value lock generation system 102 can provide a selectable option to generate a recurring value lock. To illustrate, the selectable options for a recurring value lock request include providing selectable options for a starting location (e.g., a starting location element), a destination location (e.g., a destination location element), and a recurring window (e.g., a recurring window element). In addition, the recurring value lock generation system 102 provides selectable options for generating a request associated with the recurring value lock. For example, in some embodiments, the recurring value lock generation system 102 provides a selectable option to generate a request that applies the recurring value lock.

As also illustrated in FIG. 1, environment 100 comprises a database 116. The database 116 stores data and information for implementing the transportation matching system 104 or the recurring value lock generation system 102. For example, the database 116 can manage, store, and maintain user profiles and preferences associated with the computing device 108. In some embodiments, the transportation matching system 104 or the recurring value lock generation system 102 utilize the database 116 to store and access information pertaining to user profiles, user preferences, topics, or other data related to determining contexts for interactions.

Although FIG. 1 illustrates environment 100 having a particular number and arrangement of components associated with the recurring value lock generation system 102, in some embodiments, environment 100 may include more or fewer components with varying configurations. For example, in some embodiments, the transportation matching system or the recurring value lock generation system 102 can communicate directly with the computing device 112 and/or the computing device 108, bypassing the network 118. In these or other embodiments, the transportation matching system 104 or the recurring value lock generation system 102 can be housed (entirely or in part) on the computing device 112 or the computing device 108. Additionally, the transportation matching system 104 or the recurring value lock generation system 102 can include or communicate with database 116 for storing information, such as machine-learning models, historical data (e.g., historical provider device and/or computing device patterns), requests, and/or other information described herein.

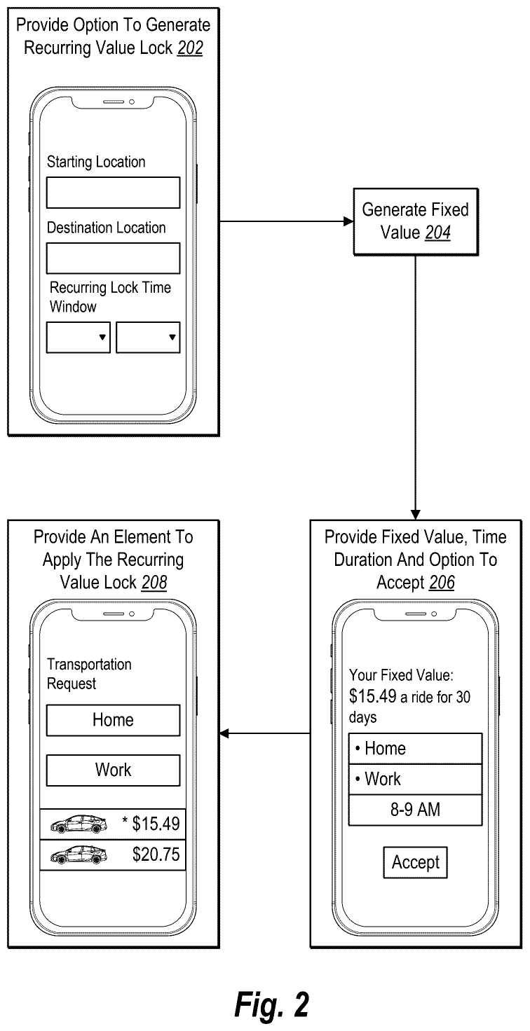

As mentioned, in one or more embodiments, the recurring value lock generation system 102 generates a recurring value lock and provides elements to apply the recurring value lock. In particular, the recurring value lock generation system 102 provides an option to generate a recurring value lock, generates a fixed value for the recurring value lock, and provides elements to apply the recurring value lock when a computing device accepts the fixed value. FIG. 2 illustrates an example sequence flow for generating a transportation value lock and providing, within a graphical user interface on a computing device, elements to apply the recurring value lock in accordance with one or more embodiments.

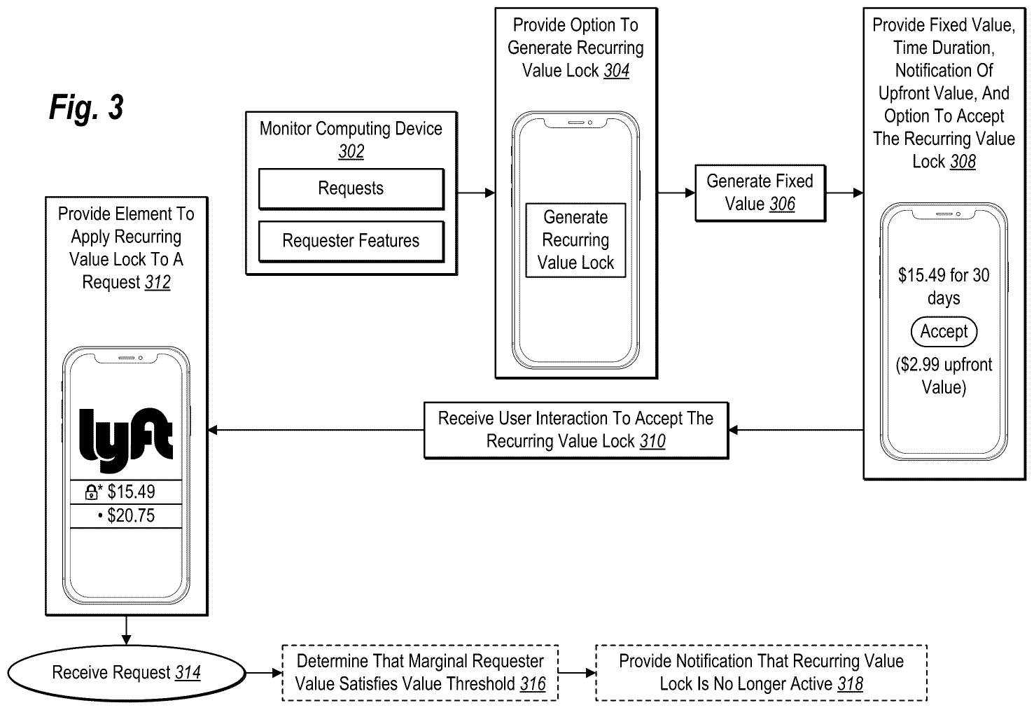

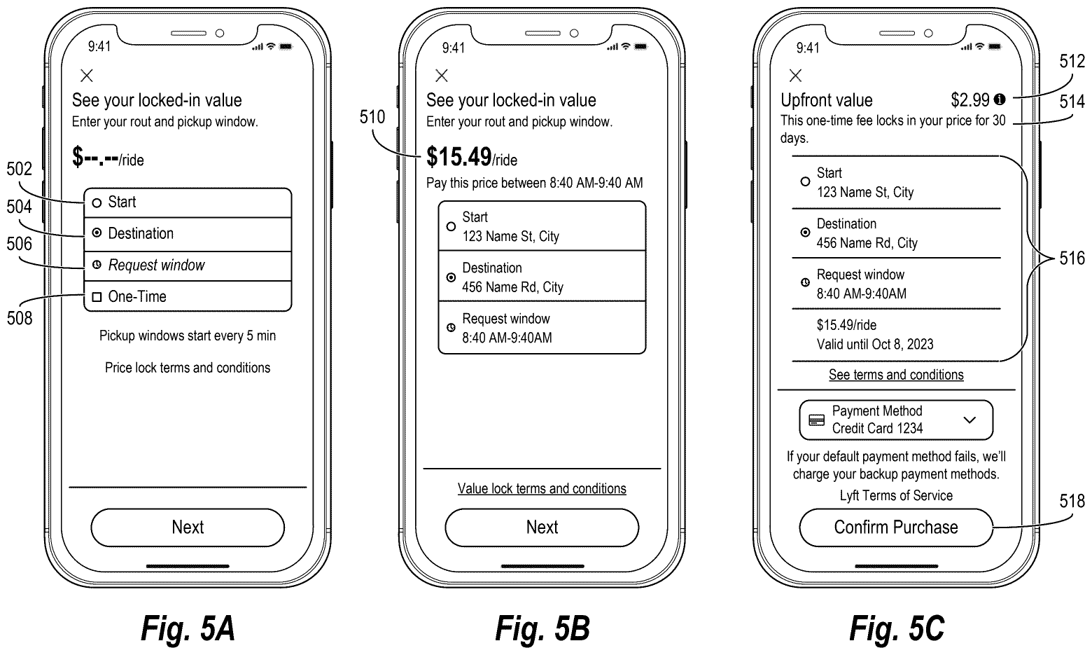

As shown in FIG. 2, the recurring value lock generation system 102 performs an act 202 to provide an option to generate a recurring value lock. For example, the recurring value lock generation system 102 provides the option to generate the recurring value lock by providing a starting location element, a destination location element, and a recurring window element in a graphical user interface on a computing device. In some cases, the recurring value lock generation system 102 provides an option to generate a recurring value lock by providing a selectable option (e.g., in an application or notification). Upon detecting a selection of the selectable option, the recurring value lock generation system 102 provides the starting location element, the destination location element, and the recurring window element. Additional information regarding the recurring value lock generation system 102 providing an option to generate a recurring value lock will be provided with respect to FIG. 3 and FIGS. 5A-5C below.

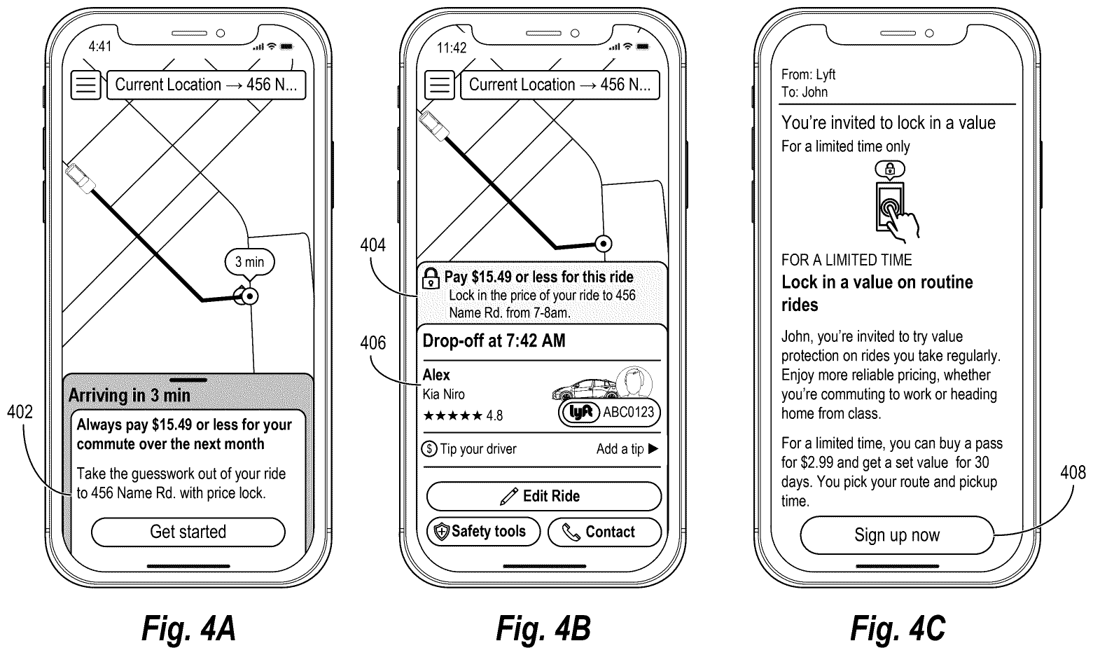

In addition, in one or more embodiments, the recurring value lock generation system 102 provides an option to generate the recurring value lock based on monitoring a computing device. Specifically, the recurring value lock generation system 102 monitors a computing device to identify requests and requester features. The recurring value lock generation system 102 then provides an option to generate the recurring value lock based on identifying that the computing device submits requests for similar times and/or to similar locations. For example, the recurring value lock generation system 102 identifies that the computing device submits a threshold number of requests and provides an option to generate a recurring value lock. Additional information regarding the recurring value lock generation system 102 providing an option to generate a recurring value lock will be provided with respect to FIG. 3 and FIGS. 4A-4C below.

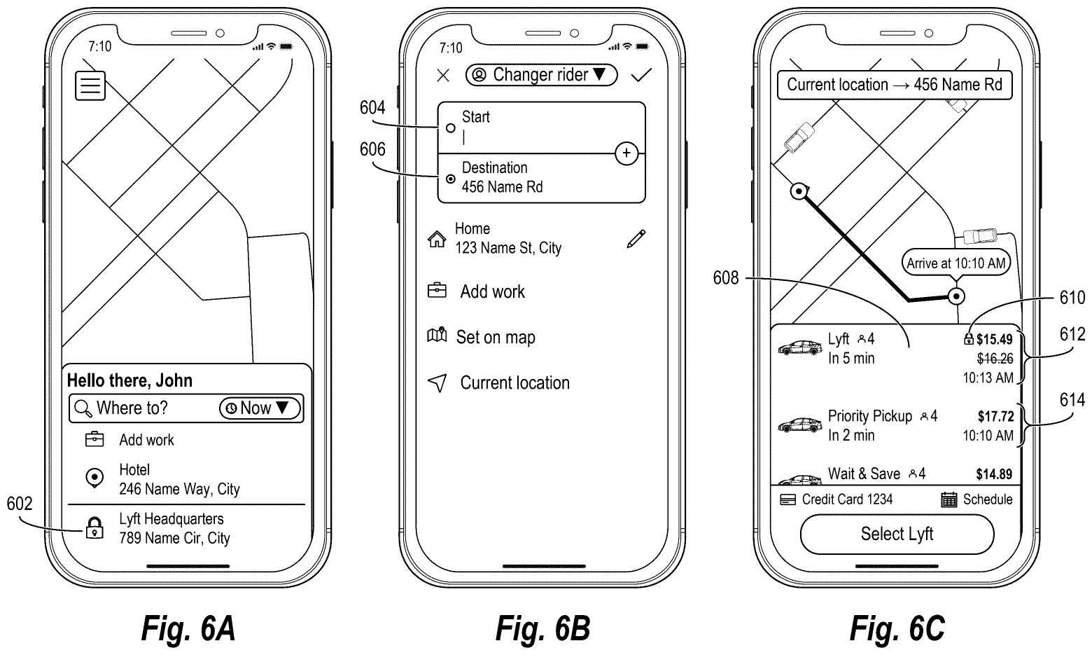

As also illustrated in FIG. 2, the recurring value lock generation system 102 performs an act 204 to generate a fixed value. In particular, the recurring value lock generation system 102 generates a fixed value for a recurring value lock to apply to a request that satisfies the recurring value lock. For example, the recurring value lock generation system 102 applies the fixed value to a request that is received within the recurring window and indicates the starting location and the destination location. When the recurring value lock generation system 102 receives a request that satisfies the recurring value lock, the recurring value lock generation system 102 provides options to utilize the fixed value for the request. Additional detail regarding the recurring value lock generation system 102 applying the fixed value to a request is provided with respect to FIGS. 6A-6C below.

In addition, as illustrated in FIG. 2, the recurring value lock generation system 102 performs an act 206 to provide the fixed value, a time duration, and an option to accept the recurring value lock. Specifically, the recurring value lock generation system 102 determines a time duration indicating a length of time for which the recurring value lock is valid. The recurring value lock generation system 102 then displays the fixed value, time duration, and an option to accept the recurring value lock. In some cases, the recurring value lock generation system 102 also displays an upfront value indicating a value incurred by the computing device to generate the recurring value lock. Additional details regarding the recurring value lock generation system 102 providing a fixed value, time duration, option to accept the recurring value lock, and upfront value are provided further with respect to FIG. 3 below and FIGS. 5A-5C.

Moreover, as illustrated, the recurring value lock generation system 102 performs an act 208 and provides an element to apply the recurring transportation lock. In one or more embodiments, the recurring value lock generation system 102 provides a notification within a request element of a graphical user interface indicating the request utilizes the fixed value of the recurring value lock. For example, based on receiving a request during the recurring lock window indicating the starting location and the destination location, the recurring value lock generation system 102 can provide an element (e.g., a notification or icon) within a request element that indicates the request utilizes the fixed value. The recurring value lock generation system 102 can also list additional request elements for additional options for the request that do not utilize the fixed value of the recurring value lock and, thus, do not comprise the element to apply that the request utilizes the fixed value. Additional details regarding the recurring value lock generation system 102 receiving a request corresponding to the transportation value lock and providing an element within a request element are provided with respect to FIGS. 6A-6C below.

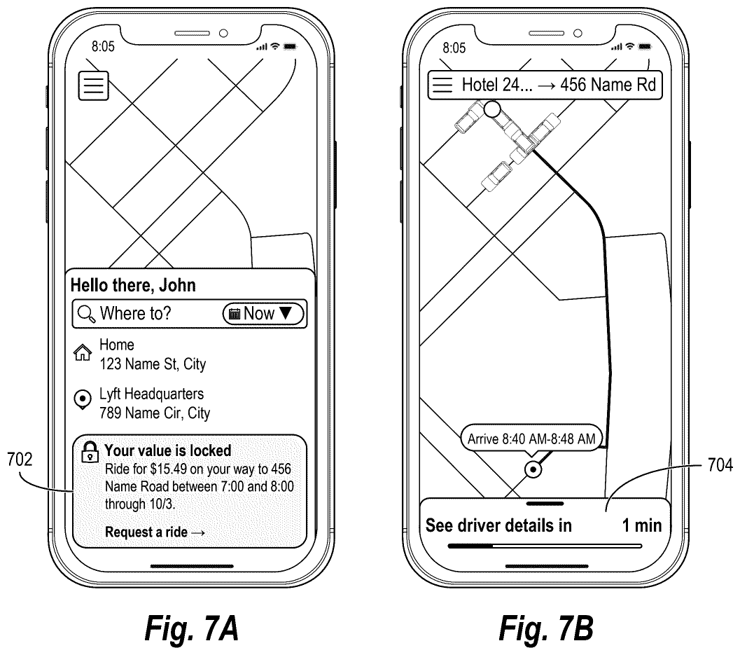

In one or more embodiments, the recurring value lock generation system 102 can provide an element to apply the recurring value lock by providing an option to generate a request from the starting location to the destination location and utilizing the fixed value. For example, the recurring value lock generation system 102 can identify initiation of a transportation application session via the computing device and provide a selectable option to initiate a request utilizing the recurring value lock (if the computing device is at the starting location during the recurring window). Based on receiving a user selection of the option to initiate the request, the recurring value lock generation system 102 can generate a transportation match with a provider device. Additional details regarding the recurring value lock generation system 102 generating an option to apply the recurring value lock based on the initiation of a transportation application session are provided with respect to FIGS. 7A-7B below.

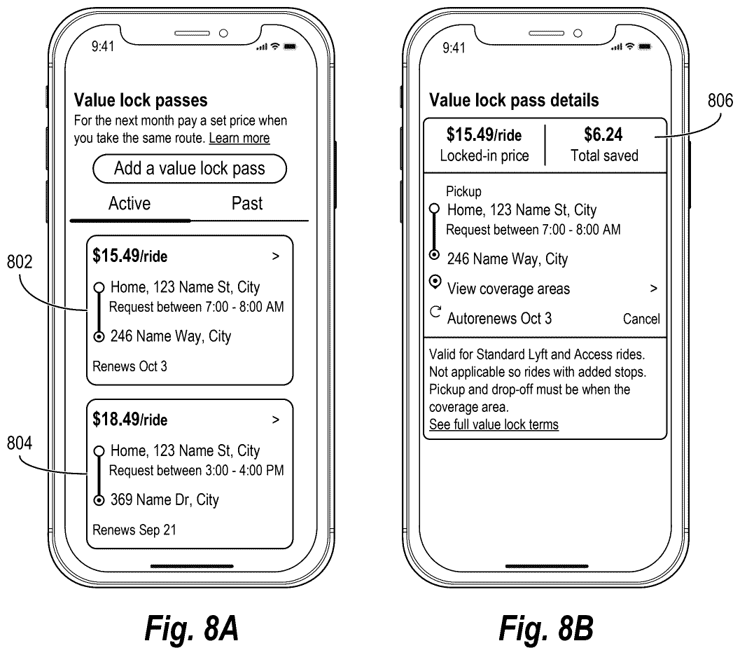

In addition, in one or more embodiments, the recurring value lock generation system 102 provides a transportation value lock management user interface to manage recurring value locks for the computing device. In particular, the recurring value lock generation system 102 provides a transportation value lock management interface within which a computing device can access information and/or data about recurring value locks associated with the computing device. For example, within the transportation value lock management user interface, the recurring value lock generation system 102 can provide the starting location, destination location, recurring window, and marginal requester value (e.g., value saved using the recurring value lock). In addition, the recurring value lock generation system 102 can also provide elements to add additional recurring value locks or manage the recurring value lock within the transportation value lock management user interface. Additional details regarding the recurring value lock generation system 102 providing a transportation value lock management user interface will be provided with respect to FIGS. 8A-8B below.

As mentioned, in one or more embodiments, the recurring value lock generation system 102 generates a recurring value lock and provides elements to apply the recurring value lock to a request. In particular, the recurring value lock generation system 102 monitors a computing device, provides options to generate a recurring value lock, and applies the recurring value lock to a request. FIG. 3 illustrates a schematic diagram of a recurring value lock generation system monitoring a computing device and providing information to generate a recurring value lock and updating a recurring value lock in accordance with one or more embodiments.

As illustrated in FIG. 3, the recurring value lock generation system 102 performs an act 302 and monitors a computing device. Specifically, the recurring value lock generation system 102 monitors requests submitted to the transportation matching system 104 from the computing device to identify whether the computing device submits requests at consistent times and/or for consistent locations. For example, the recurring value lock generation system 102 monitors times and locations (e.g., starting and destination locations) for which a computing device submits requests and determines a recurring transportation pattern.

As mentioned, the recurring value lock generation system 102 can also monitor or identify requester features of the computing device. Specifically, the recurring value lock generation system 102 monitors requester features to utilize when determining whether to provide an option to generate a recurring value lock. For example, the recurring value lock generation system 102 monitors user historical request features that indicate historical requests submitted by the computing device. In addition, the recurring value lock generation system 102 monitors user location features that indicate the current or historical locations of the computing device. Further, the recurring value lock generation system 102 monitors user account data features comprising data associated with a user account of a transportation matching system. Moreover, the recurring value lock generation system 102 monitors transportation application interaction features comprising interactions of the computing device with a transportation application (e.g., initiating a transportation application session, interactions with elements in the transportation application, unsubmitted requests).

As also illustrated in FIG. 3, the recurring value lock generation system 102 performs an act 304 and provides an option to generate a recurring value lock. Specifically, the recurring value lock generation system 102 determines whether to provide an option to generate a recurring value lock based on the requests and requester features monitored on the requester computer device. For example, after monitoring the computing device, the recurring value lock generation system 102 determines that the computing device would utilize a recurring value lock and provide an option to generate a recurring value lock.

In one or more embodiments, the recurring value lock generation system 102 determines to provide an option to generate the recurring value lock based on determining a recurring transportation pattern. In particular, the recurring value lock generation system 102 identifies that the computing device submits requests that satisfy recurring transportation pattern requirements. For example, the recurring value lock generation system 102 identifies that a computing device submits requests from a first location to a second location during a time window that satisfies recurring transportation pattern requirements. In some cases, the recurring value lock generation system 102 determines that requests satisfy recurring transportation pattern requirements based on the computing device submitting a number of requests that satisfy a recurring request threshold. To illustrate, the recurring value lock generation system 102 can determine that the computing device submitted a number of requests between 8:00 a.m. and 9:00 a.m. from a first location to a second location that satisfy a recurring request threshold and provide an option to generate a recurring value lock to the computing device.

The recurring value lock generation system 102 provides an option to generate a recurring value lock by providing elements to receive user input of information to generate the recurring value lock. Specifically, the recurring value lock generation system 102 provides a starting location element, a destination location element, and a recurring window element within a graphical user interface on a computing device. The recurring value lock generation system 102 can receive a user interaction with the starting location element to indicate a starting location, the destination location element to indicate a destination location, and/or the recurring window element to indicate a recurring window for a recurring value lock. To illustrate, the recurring value lock generation system 102 receives a user input of a starting location (e.g., home address of the computing device), a destination location (e.g., work address of the computing device), and a recurring window (e.g., 8:00 a.m. to 9:00 a.m. on a particular day of the week or set of days) for the recurring value lock.

In some embodiments, the recurring value lock generation system 102 provides a selectable option to generate a recurring request. In particular, the recurring value lock generation system 102 provides a selectable option that, upon user selection of the selectable option, generates the starting location element, the destination location element, and the recurring window element. For example, the recurring value lock generation system 102 can provide a notification with a selectable option in a transportation application of the computing device when the computing device submits a request. As another example, the recurring value lock generation system 102 can provide a selectable option in a digital communication between the recurring value lock generation system 102 (or the transportation matching system 104) and the computing device (e.g., an email).

The recurring value lock generation system 102 can provide additional options for user preferences when providing options to generate a recurring value lock. Specifically, the recurring value lock generation system 102 can provide options for types of requests, such as a request for a particular vehicle mode or upgrade (e.g., size or type of vehicle). For example, the recurring value lock generation system 102 determines that the computing device typically submits an additional mode request and provides an option for an additional mode request for the recurring value lock. Additional details and examples of the recurring value lock generation system 102 providing selectable options for generating a recurring value lock are provided below with respect to FIGS. 4A-4B.

As further illustrated in FIG. 3, the recurring value lock generation system 102 performs an act 306 and generates a fixed value. Specifically, the recurring value lock generation system 102 generates a fixed value indicating a value for a request submitted by the computing device that corresponds to the starting location, destination location, and recurring time lock window of the recurring value lock. For example, the recurring value lock generation system 102 can generate a fixed value of $15.49 for a request from a starting location (e.g., a work address) to a destination location (e.g., a home address) and received during a recurring window (e.g., 6:00 p.m. to 7:00 p.m.). Moreover, the recurring value lock generation system 102 generates a fixed value as a cap for what someone will pay for a regular request location during the recurring time lock window. Specifically, a fixed value refers to a maximum price for a regular request from the starting location to the destination location during the recurring window. The recurring value lock generation system 102 may also generate additional values for other types of requests (e.g., extra comfort, wait and save) that may be higher or lower than the fixed value.

In one or more embodiments, the recurring value lock generation system 102 utilizes a fixed value model to generate a fixed value for a recurring value lock. Specifically, the recurring value lock generation system 102 utilizes a fixed value model that generates a fixed value based on location-time combinations corresponding to the starting location, the destination location, and the recurring window. For example, the recurring value lock generation system 102 accesses historic request data corresponding to the locations during the recurring window. To illustrate, the recurring value lock generation system 102 can determine a fixed value by utilizing historic request data to determine an average value for a request from the starting location to the destination location and utilizing the average value for the fixed value.

Further, the recurring value lock generation system 102 can generate the fixed value by adjusting or modifying an average value. Specifically, the recurring value lock generation system 102 can adjust the average value by adding or taking away from the average value. For example, the recurring value lock generation system 102 can adjust an average value by utilizing a portion of the average value (e.g., 95%). As another example, the recurring value lock generation system 102 can adjust the average value by adding a value amount to the average value (e.g., 105% or $2 more).

In addition, in one or more embodiments, the recurring value lock generation system 102 generates a fixed value by accounting for predicted events. Specifically, the recurring value lock generation system 102 identifies events that may affect a value of a request submitted for the starting location and the destination location during the recurring time lock window and adjusts the fixed value. For example, for recurring value locks during the winter in climates that experience winter storms, the recurring value lock generation system 102 can increase the fixed value to account for the likelihood of a winter storm that would generally increase request values. As another example, the recurring value lock generation system 102 can identify that there is a holiday that would affect the recurring value lock and will adjust a fixed value by increasing or decreasing a value (e.g., an average value) based on historical values for the holiday.

In one or more embodiments, the recurring value lock generation system 102 uses traffic data to generate a fixed value. Specifically, the recurring value lock generation system 102 can interface with a traffic application (e.g., of the transportation matching system 104) to determine traffic data indicating typical traffic patterns from the starting location to the destination location and utilize the traffic data when generating the fixed value. For example, if the traffic data indicates that a route has increased traffic during the recurring window, then the recurring value lock generation system 102 will generate a higher (or increased) fixed value. To illustrate, if the recurring window is during a high traffic time window (e.g., 8:00 a.m. to 9:00 a.m.), then the recurring value lock generation system 102 can increase an average value to account for the traffic.

The recurring value lock generation system 102 can also generate additional fixed values for the recurring request. Specifically, the recurring value lock generation system 102 can generate a modified fixed value for a modified recurring value lock comprising adjustments in the starting location, the destination location, or the recurring time lock window. For example, the recurring value lock generation system 102 can determine a modified fixed value for a modified recurring window that is different from the time frame provided in the recurring window element (e.g., $15.49 for 8:00 a.m. to 9:00 a.m. and $13.50 for 7:30 a.m. to 8:30 a.m.). As another example, the recurring value lock generation system 102 can determine a modified fixed value for a modified location, such as a location that is a short distance from the starting location or the destination location (e.g., $17.00 from the starting location and $12.00 from a location that is a 10-minute walk from the starting location).

As illustrated in FIG. 3, the recurring value lock generation system 102 performs an act 308 and provides a fixed value, a time duration, a notification of the upfront value, and an option to accept the recurring value lock. Specifically, the recurring value lock generation system 102 provides the fixed value by providing the fixed value generated (e.g., in act 306) corresponding to a request from the starting location to the destination location and during the recurring window.

As mentioned, the recurring value lock generation system 102 provides a time duration. In particular, the recurring value lock generation system 102 provides a time duration corresponding to a length of time during which the fixed value will be valid for a request from the starting location to the destination location. For example, a time duration can be a set length of time (e.g., 30 days) or until a certain date (e.g., October 3).

In one or more embodiments, the recurring value lock generation system 102 determines a time duration for the recurring value lock. Specifically, the recurring value lock generation system 102 can identify additional events, features, or data and determine a time duration based on the events, features, or data. For example, the recurring value lock generation system 102 can identify that a construction project is scheduled to begin 10 days after receiving a request to generate a recurring value lock and determine to generate a time duration of 10 days for the recurring value lock. As another example, the recurring value lock generation system 102 can determine that values are variable for location-time combinations of the recurring value lock and determine to generate a decreased time duration (e.g., 2 weeks instead of 30 days).

As mentioned, the recurring value lock generation system 102 provides a notification of an upfront value. In particular, the recurring value lock generation system 102 provides a notification of an upfront value for generating a recurring value lock. In some cases, an upfront value is a set value that the recurring value lock generation system 102 charges for generating a recurring value lock (e.g., $2.99). In other cases, the recurring value lock generation system 102 determines an upfront value for a recurring value lock, such as by determining that the computing device has a recurring value lock and decreasing the price for an additional recurring value lock (e.g., regularly $6.99, but $4.99 for an additional).

As mentioned, the recurring value lock generation system 102 provides an option to accept a recurring value lock. Specifically, the recurring value lock generation system 102 provides a selectable option that, based on user interaction with the option, generates a recurring value lock. For example, user interaction with the option to accept the recurring value lock accepts the terms of the recurring value lock, including the fixed value, the time duration, and the upfront value.

In addition, though not illustrated, the recurring value lock generation system 102 can provide an option to accept a modified recurring value lock. Specifically, the recurring value lock generation system 102 can provide an option to accept a modified recurring value lock that adjusts the recurring window or the locations and has a corresponding modified fixed value. For example, the recurring value lock generation system 102 can provide an option to accept a modified fixed value corresponding to a recurring value lock with a modified recurring value lock window (e.g., $20 for 8:30 a.m. to 9:30 a.m. vs. $15 for 9:00 a.m. to 10:00 a.m.). As another example, the recurring value lock generation system 102 can provide an option to accept a modified recurring value lock with a modified location (e.g., $10.75 for the destination location vs. $8 for a location that is a 5-minute walk from the destination location).

As illustrated in FIG. 3, the recurring value lock generation system 102 performs an act 310 and receives a user interaction to accept the recurring value lock. Specifically, based on receiving a user interaction to accept the recurring value lock, the recurring value lock generation system 102 generates a recurring value lock. The recurring value lock generation system 102 generates a recurring value lock for a fixed value, starting location, destination location, recurring window, time duration, and upfront value indicated with the option to accept the recurring value lock.

Further, as illustrated in FIG. 3, the recurring value lock generation system 102 performs an act 312 and provides an element to apply a recurring value lock to a request. Specifically, the recurring value lock generation system 102 provides an element that indicates a request complies with the recurring value lock and utilizes the fixed value of the recurring value lock. For example, the recurring value lock generation system 102 provides an element in a graphical user interface of a transportation application that applies the recurring value lock. As another example, the recurring value lock generation system 102 can provide an element within a request element that indicates that the request applies the recurring value lock. For example, the recurring value lock generation system 102 can provide a notification element or icon within a request element indicating that the request utilizes the recurring value lock. Additional details and examples of the recurring value lock generation system 102 providing an element to apply the recurring value lock are provided below with respect to FIGS. 6A-6B.

In one or more embodiments, the recurring value lock generation system 102 provides a selectable option to generate a request based on the initiation of a transportation application session on the computing device. In particular, the recurring value lock generation system 102 provides the selectable option based on identifying that the computing device is located at the starting location and that the current time of the computing device is within the recurring window. In some cases, when the recurring value lock generation system 102 receives a user interaction with the selectable option to generate a request, the recurring value lock generation system 102 also generates a transportation match with a provider device to the starting location. Additional details and examples of the recurring value lock generation system 102 providing a selectable option to generate a request based on the initiation of a transportation application are provided below with respect to FIGS. 7A-7B.

As also illustrated in FIG. 3, in one or more embodiments, the recurring value lock generation system 102 performs an act 314 and receives a request. Specifically, the recurring value lock generation system 102 receives user interactions to initiate a request utilizing the recurring value lock. For example, the recurring value lock generation system 102 can receive, during the recurring window, a starting location and destination location in a request initiation element of a graphical user interface that corresponds to the starting location and destination location of the recurring value lock. As another example, the recurring value lock generation system 102 can receive a user interaction with an option to initiate a request utilizing the recurring value lock.

The recurring value lock generation system 102 also intelligently accounts for requests during the recurring window (e.g., by positioning, reserving, or matching provider devices based on anticipated request corresponding to transportation value locks). Specifically, the recurring value lock generation system 102 anticipates receiving a request from the computing device during the recurring window and accounts for the request when generating transportation matches. For example, the recurring value lock generation system 102 positions computing devices (e.g., provider computing devices) in anticipation of receiving a request from the computing device, such as by transmitting digital notifications for a provider device to come online. As another example, the recurring value lock generation system 102 reserves computing devices for the anticipated request by generating transportation matches to additional computing devices. Indeed, by anticipating requests the recurring value lock generation system 102 is able to generate more efficient requests between computing devices and computing devices. Additional details and examples of the recurring value lock generation system 102 generating a request are provided below with respect to FIGS. 6A-6C.

As illustrated in FIG. 3, the recurring value lock generation system 102 can perform an act 316 and determine that a marginal requester value satisfies a value threshold. Specifically, the recurring value lock generation system 102 determines that a marginal requester value comprising a total value of the recurring value lock (e.g., the total value saved by using the recurring value lock) satisfies a value threshold. For example, a marginal requester value satisfies a value threshold when the marginal request value exceeds the value threshold. To illustrate, for a value threshold of $40, the marginal requester value exceeds the value threshold when the difference in the total amount saved using the recurring value lock compared to requests at the same time exceeds $40 (e.g., using the recurring value lock saved $40). For example, the transportation value lock generation system 102 compares the fixed value applied to any requests with baseline transportation values (e.g., values of baseline requests at the same times from the starting location to the destination) to determine the marginal requester value. The system then compares the marginal requester value to the value threshold to determine whether to apply or deactivate the transportation value lock.

In one or more embodiments, in response to determining that the marginal requester value satisfies the value threshold, the recurring value lock generation system 102 will deactivate a recurring value lock. Specifically, the recurring value lock generation system 102 will remove options and elements to apply the transportation value lock and cease providing selectable options to apply the recurring value lock. In some cases, the recurring value lock generation system 102 deactivates the recurring value lock for the remainder of the time duration for the recurring value lock and prevents the computing device from generating an additional recurring value lock for the corresponding locations and recurring time lock window. In other cases, the recurring value lock generation system 102 deactivates the recurring value lock and allows the computing device to generate an additional recurring value lock for the corresponding locations and recurring time lock window with an updated fixed value (e.g., a higher fixed value).

As also illustrated in FIG. 3, the recurring value lock generation system 102 performs an act 318 and provides a notification that the recurring value lock is no longer active. Specifically, the recurring value lock generation system 102 provides a notification that the recurring value lock is no longer active in response to determining that a marginal requester value satisfies a value threshold. For example, the recurring value lock generation system 102 can provide the notification as a pop-up, as a digital communication (e.g., an email), or by providing an indication within a request initiation interface.

In one or more embodiments, the recurring value lock generation system 102 generates a non-recurring value lock. In particular, the recurring value lock generation system 102 generates a non-recurring value lock as a one-time value lock (e.g., is not recurring) corresponding to a fixed value and a time duration. For example, during the time duration of a non-recurring value lock, the fixed value is valid for request between a specified starting location and a specified destination location for the length of the time duration. After the time duration (e.g., the time duration is expired), the non-recurring value lock is no longer active. As an illustration, a client device may need a transportation service at a future time period (e.g., will need a transportation service from an airport to a destination location but needs to walk to the starting location or wait for checked bags) and wants to secure a price for the transportation service. Based on user input of a starting location (e.g., the airport), a destination location, and, in some cases, a time duration (e.g., two-hours), the recurring value lock generation system 102 can generate a non-recurring value lock for a fixed value for the time duration. During the time duration (e.g., two hours), the fixed value will be valid for a request between the starting location and the destination location and after expiration of the time duration (e.g., at the end of two hours), the non-recurring value lock becomes inactive.

In some embodiments, the recurring value lock generation system 102 generates a non-recurring value lock based on monitoring the computing device. Specifically, based on monitoring requester a computing device (e.g., during act 302), the recurring value lock generation system 102 can determine that the computing device is likely to request a transportation service within a threshold amount of time and perform act 304 by providing an option to generate a non-recurring value lock. For example, the recurring value lock generation system 102 can identify that a location for a requester client device corresponds to a location where a user is likely to submit a request (e.g., an airport) and provide an option to generate the non-recurring value lock.

As previously mentioned, the recurring value lock generation system 102 provides an option to generate a recurring value lock. Specifically, the recurring value lock generation system 102 provides selectable options to generate a recurring value lock and, upon receiving a user interaction with the selectable option, provides elements to generate a recurring value lock. FIGS. 4A-4C illustrate an exemplary series of graphical user interfaces of the recurring value lock generation system providing an option to generate a recurring value lock in accordance with one or more embodiments. Specifically, FIG. 4A illustrates an exemplary graphical user interface that provides an option to generate a recurring value lock after the completion of a transportation service. FIG. 4B illustrates an exemplary graphical user interface that provides an option to generate a recurring value lock during a transportation service. FIG. 4C illustrates an exemplary graphical user interface for providing an option to generate a recurring value lock in a digital communication.

As illustrated in FIG. 4A, in one or more embodiments, the recurring value lock generation system 102 provides an option 402 to generate a recurring transportation value after completion of a transportation service. Specifically, the recurring value lock generation system 102 provides an option 402 to generate the recurring value lock in a graphical user interface of a transportation application within which the computing device submits a request and/or views the progress of a transportation service. For example, the recurring value lock generation system 102 can determine to provide an option to generate a recurring value lock (as described above) and provide the option within a window of the graphical user interface.

In one or more embodiments, the recurring value lock generation system 102 provides the option to generate the recurring value lock in response to determining that a transportation service is completed. Specifically, the recurring value lock generation system 102 determines, based on the location of the computing device (e.g., the requestor computing device and/or the provider computing device), that the transportation service satisfies a transportation service completion threshold and provides the option to generate the recurring value lock. For example, the recurring value lock generation system 102 can utilize a transportation service completion threshold corresponding to the amount of the transportation service completed. To illustrate, for a transportation service completion threshold of 90%, the recurring value lock generation system 102 provides an option to generate a recurring value lock when a transportation service is 90% completed. As another example, the recurring value lock generation system 102 can utilize a transportation service completion threshold corresponding to the amount of time remaining in the transportation service. To illustrate, for a transportation service completion threshold of 3 minutes, the recurring value lock generation system 102 can determine that 3 minutes are left in the transportation service and provide the option to generate the recurring value lock.

As illustrated in FIG. 4B, the recurring value lock generation system 102 can also provide an option 404 to generate a recurring value lock during a transportation service. In particular, the recurring value lock generation system 102 provides the option 404 to generate the recurring value lock based on determining that the transportation service has commenced. For example, the recurring value lock generation system 102 can determine that the transportation matching service has initiated the transportation service (e.g., based on input from a provider computing device) and provide an option 404 to generate a recurring value lock.

In one or more embodiments, the recurring value lock generation system 102 provides an option 404 with information 406 for the transportation service. Specifically, the recurring value lock generation system 102 provides an option 404 within a graphical user interface displaying information 406 pertaining to the transportation service. For example, based on identifying an initiation of a transportation service, the recurring value lock generation system 102 updates a graphical user interface to include information 406 corresponding to the transportation service and provides the option 404 with the updated graphical user interface.

As illustrated in FIG. 4C, the recurring value lock generation system 102 can also provide an option 408 to generate a recurring value lock within a digital communication. In particular, the recurring value lock generation system 102 can provide a digital communication to a computing device based on determining a recurring transportation pattern of the computing device. For example, the recurring value lock generation system 102 can provide digital communication by providing an email, a text message, a social media message, or a direct message (e.g., within a transportation application).

As previously mentioned, the recurring value lock generation system 102 provides options to generate a recurring value lock by providing elements to generate the recurring value lock. Specifically, the recurring value lock generation system 102 provides elements for receiving user interactions to generate the recurring value lock. FIGS. 5A-5C illustrate an exemplary series of graphical user interfaces of the recurring value lock generation system 102 providing elements to generate a recurring value lock in accordance with one or more embodiments. Specifically, FIG. 5A illustrates an example graphical user interface for providing a starting location element, a destination location element, and a recurring time window element, FIG. 5B illustrates an example graphical user interface displaying a fixed value element and an option to accept the fixed value, FIG. 5C illustrates an example graphical user interface displaying an upfront value element and an option to accept the recurring value lock with the upfront value.

As illustrated in FIG. 5A, the recurring value lock generation system 102 provides elements for generating a recurring value lock. Specifically, the recurring value lock generation system 102 provides a starting location element 502, a destination location element 504, and a recurring window element 506. Within the starting location element 502, the recurring value lock generation system 102 receives a user interaction indicating a starting location for a recurring value lock (e.g., home address). In addition, within the destination location element 504, the recurring value lock generation system 102 receives a user interaction indicating a destination location for a recurring value lock (e.g., work address). Further, within the recurring window element, the recurring value lock generation system 102 receives a user interaction indicating a recurring window for a recurring value lock (e.g., 8:00 a.m. to 9:00 a.m.).

In one or more embodiments, the recurring value lock generation system 102 displays starting location element 502, destination location element 504, and recurring window element 506 in response to a user interaction with an option to generate a recurring value lock (as described above in relation to FIGS. 4A-4C). For example, the recurring value lock generation system 102 generates (or updates) a graphical user interface comprising the starting location element 502, the destination location element 504, and the recurring window element 506 based on receiving a user interaction with an option to generate a recurring value lock. In some embodiments, the recurring value lock generation system 102 also generates a non-recurring value lock element 508. For instance, the recurring value lock generation system 102 generates non-recurring value lock element 508 when the recurring value lock generation system 102 identifies (by generating a likelihood) that a requester client device is likely to submit a request for a transportation service within a threshold amount of time and provide non-recurring value lock element 508.

As illustrated in FIG. 5B, in one or more embodiments, the recurring value lock generation system 102 provides a fixed value element 510 to display a fixed value for a recurring value lock. Specifically, the recurring value lock generation system 102 generates a fixed value based on receiving a user interaction indicating a starting location, destination location, and a recurring time lock window and provides a fixed value element with the generated fixed value. For example, as shown, the recurring value lock generation system 102 generates the fixed value and presents it within a graphical user interface on the computing device.

As illustrated in FIG. 5C, in one or more embodiments, the recurring value lock generation system 102 provides elements and/or options to accept a recurring value lock. For example, the recurring value lock generation system 102 provides an upfront value element 512 to display an upfront value for generating the recurring value lock. The recurring value lock generation system 102 can generate or select an upfront value (as described with respect to FIG. 3) for a recurring value lock that indicates a value for generating a recurring value lock. As shown, the recurring value lock generation system 102 displays the upfront value prior to generating the recurring value lock.

In addition, as shown, the recurring value lock generation system 102 provides a time duration element 514. In particular, the recurring value lock generation system 102 provides a time duration for which the recurring value lock is valid in the time duration element 514. For example, the recurring value lock generation system 102 can determine a time duration for the recurring value lock (as described with respect to FIG. 3) and display the time duration in the time duration element 514.

Also, as shown, the recurring value lock generation system 102 provides a recurring value lock specifications element 516 recurring value lock. Specifically, the recurring value lock generation system 102 provides specifications corresponding to the recurring value lock in the recurring value lock specifications element 516 recurring value lock. For example, the recurring value lock generation system 102 displays the specifications that satisfy the recurring value lock, including starting location, destination location, recurring window, and/or fixed value, within the recurring value lock specifications element 516 recurring value lock.

In addition, as shown, the recurring value lock generation system 102 provides an option 518 to accept the recurring value lock. In particular, the recurring value lock generation system 102 generates the recurring value lock based on receiving a user interaction with option 518 to accept the recurring value lock and the associated specifications. For example, based on receiving a user interaction with option 518 to accept the recurring value lock, the recurring value lock generation system 102 generates the recurring value lock with the specifications as displayed in the recurring value lock specifications element 516 recurring value lock.

As previously mentioned, the recurring value lock generation system 102 provides an element to apply the recurring value lock to a request. In particular, the recurring value lock generation system 102 provides an element in association with a request that indicates the request utilizes the recurring value lock. FIGS. 6A-6C illustrate an exemplary series of graphical user interfaces of the recurring value lock generation system 102 providing an element to apply a recurring value lock to a request in accordance with one or more embodiments. Specifically, FIG. 6A illustrates an example graphical user interface of the recurring value lock generation system 102 providing an option to generate a request utilizing the recurring value lock. FIG. 6B illustrates an example graphical user interface of the recurring value lock generation system 102 receiving a user input of a starting location and destination location for a transportation value lock. FIG. 6C illustrates an example graphical user interface of the recurring value lock generation system 102 providing a notification that indicates a request element applies a recurring value lock.

As illustrated in FIG. 6A, in one or more embodiments, the recurring value lock generation system 102 displays an option 602 to generate a request utilizing a recurring value lock in a graphical user interface. Specifically, the recurring value lock generation system 102 displays the option in response to determining that the current location of the computing device is the starting location, and a current time satisfies the recurring window. For example, the recurring value lock generation system 102 can determine that the computing device is located within a threshold distance of the starting location and that a current time associated with the computing device is within the recurring window (e.g., the computing device indicates it is 8:45 a.m. and the recurring window is 8:30 a.m. to 9:30 a.m.). In some cases, the recurring value lock generation system 102 provides the option within a home screen of a transportation application.

In one or more embodiments, the recurring value lock generation system 102 displays option 602 as an option to generate a non-recurring value lock. More specifically, the recurring value lock generation system 102 can provide option 602 to generate a non-recurring value lock based on determining that a computing device is likely to submit a request. For example, based on determining that a computing device is at a location where the computing device is likely to submit a request (e.g., the computing device traveled to an airport in a different city from where the computing device usually is located), the recurring value lock generation system 102 can generate option 602 to generate a non-recurring value lock.

In one or more embodiments, the recurring value lock generation system 102 provides an option to generate a request utilizing a recurring value lock based on identifying the initiation of a transportation application session via the computing device. For example, the recurring value lock generation system 102 identifies initiation of a transportation application session while the current location of the computing device is the starting location, and the current time of the computing device is during the recurring window.

In addition, the recurring value lock generation system 102 can begin forecasting for an anticipated request based on the computing device initiating the transportation application session. Specifically, the recurring value lock generation system 102 determines (e.g., predicts a probability that satisfies a threshold probability) that the computing device will submit a request utilizing the recurring value lock and perform actions in anticipation of receiving the request. For example, the recurring value lock generation system 102 can transmit digital notifications to computing devices to come online or to generate an upfront transportation match with the computing device. In some cases, the recurring value lock generation system 102 will generate an upfront dispatch directing a computing device to the starting location of the recurring value lock in anticipation of receiving the request. In this manner, the recurring value lock generation system 102 can further improve efficiency and flexibility relative to conventional systems. Indeed, the recurring value lock generation system 102 can improve network coverage of computing devices and improve matching efficiency while reducing unnecessary bandwidth utilization and computer resources associated with inefficient transportation matches (e.g., duplicative queries and communications associated with inefficient transportation matches).

In some embodiments, the recurring value lock generation system 102 provides the option to generate a request that, when selected, generates a request element within a listing of request elements, as described and illustrated with respect to FIG. 6C. In addition, in one or more embodiments, the recurring value lock generation system 102 provides an option to generate a request that, when selected, generates a request and a corresponding transportation match with a provider device, as described and illustrated with respect to FIGS. 7A-7B.

As illustrated in FIG. 6B, in one or more embodiments, the recurring value lock generation system 102 can provide an element to apply a request based on receiving a user input of a starting location and a destination location that satisfy the recurring value lock. In particular, the recurring value lock generation system 102 can provide a user-defined starting location element 604 and a user-defined destination element 606 and, based on user input, generate a request utilizing a recurring value lock. For example, the recurring value lock generation system 102 can generate a request element with a corresponding indication that the request utilizes a recurring value lock, as illustrated in FIG. 6C.

As illustrated in FIG. 6C, in one or more embodiments, the recurring value lock generation system 102 provides a request element that utilizes a recurring value lock. In particular, the recurring value lock generation system 102 provides a request element 612 and an additional request 614 in a listing of request elements 608. For example, the recurring value lock generation system 102 (or the transportation matching system 104) generates various types of requests with corresponding values and provides them in request elements in the listing of request elements 608. To illustrate, the recurring value lock generation system 102 (or the transportation matching system 104) generates a request utilizing the recurring value lock with the corresponding fixed value, a ‘priority pickup’ request with a corresponding value, and a ‘wait and save’ request with a corresponding value. Based on user interaction with one of the transportation elements of the listing of request elements 608, the recurring value lock generation system 102 (or the transportation matching system 104) initiates a transportation service and generates a transportation match with a provider computing device.

As shown, the recurring value lock generation system 102 can display values associated with requests of the listing of request elements 608. In particular, the recurring value lock generation system 102 generates a value for each request and provides the value corresponding to the request. For example, the recurring value lock generation system 102 provides the fixed value for the request of request element 612 (together with a current value, with strike through, that indicates the current value without application of the fixed value) and a value for additional request element.

Also, as shown, the fixed value corresponds to a regular request, while the additional request 614 has a higher value as is it a ‘priority pickup’ request. Moreover, the recurring value lock generation system 102 generates a lower value for a ‘wait and save’ request and the computing device may select that option. Indeed, after generating a recurring value lock, the recurring value lock generation system 102 will provide the fixed price as an option for a regular request but the computing device may select any of the request elements in the listing of request elements 608. The recurring value lock generation system 102 does not require the computing device to select the request with the corresponding fixed value.

In addition, as mentioned, the recurring value lock generation system 102 provides an indication 610 corresponding to request element 612 that indicates request element 612 utilizes the recurring value lock. Specifically, the recurring value lock generation system 102 provides an indication 610 by providing one of multiple types of indications. For example, indication 610 can comprise an icon representing the recurring value lock. As another example, indication 610 can comprise a pop-up notification that a request utilizes the transportation value lock. As a further example, indication 610 can comprise a shading of the request element 612 that indicates it utilizes the recurring value lock.

In one or more embodiments, as shown, the recurring value lock generation system 102 provides a current value for a request for display in request element 612. Specifically, the recurring value lock generation system 102 generates a current value for a request from the starting location to the destination location and provides the current value for display with the fixed value (e.g., to show the value difference between the fixed value and the current value). In some cases, when a current value for a request is lower than the fixed value, the recurring value lock generation system 102 elects to only display the current value and elect to not display the indication of the recurring value lock and the fixed price.

As mentioned, in one or more embodiments, the recurring value lock generation system 102 provides an option to generate a request utilizing a transportation value lock and a corresponding transportation match with a provider device. In particular, the recurring value lock generation system 102 determines that the current location and current time of a computing device satisfy a recurring value lock and provides an option to generate a request utilizing the recurring value lock and a corresponding transportation match with a provider device. FIGS. 7A-7B illustrate an exemplary series of graphical user interfaces of the recurring value lock generation system providing a selectable option to generate a request applying a transportation value lock and a corresponding transportation match with a provider device in accordance with one or more embodiments. Specifically, FIG. 7A illustrates the recurring value lock generation system 102 providing an option to generate a request utilizing a recurring value lock and FIG. 7B illustrates generating a transportation match with a provider computing device.

As illustrated in FIG. 7A, in one or more embodiments, the recurring value lock generation system 102 generates an option 702 to generate a request utilizing a recurring value lock. In particular, the recurring value lock generation system 102 generates an option 702 to generate a transportation lock that, when selected, generates a request and a corresponding transportation match with a provider device. For example, the recurring value lock generation system 102 provides option 702 in response to detecting that the current location of the computing device is the starting location and the current time of the computing device satisfies the recurring window.

In one or more embodiments, the recurring value lock generation system 102 provides the option 702 to generate a request based on a user setting. For example, the recurring value lock generation system 102 identifies that a user setting for a recurring value lock indicates a preference for an option to generate a request with a single selection. As another example, the recurring value lock generation system 102 can provide a user setting for a request on certain days of the week (e.g., Monday, Wednesday, Friday) and generates the option 702 based on identifying the user setting. In some cases, the recurring value lock generation system 102 can provide options for user settings of a recurring value lock within a recurring value lock management interface.

As illustrated in FIG. 7B, in one or more embodiments, based on a user selection of the option 702, the recurring value lock generation system 102 provides a display element 704 indicating transportation match with a provider device. In particular, the recurring value lock generation system 102 generates a transportation match with a provider device based on receiving a selection of option 702 and provides a display on the computing device indicating the transportation match. For example, as shown, the recurring value lock generation system 102 provides display element 704, which indicates that the recurring value lock generation system 102 (or the transportation matching system 104) generates the transportation match. The recurring value lock generation system 102 can update display element 704 upon identifying a provider device for the request (e.g., to include provider device details).

In addition, in one or more embodiments, the recurring value lock generation system 102 also generates a dispatch for a provider computing device to the starting location. Specifically, the recurring value lock generation system 102 transmits a dispatch (with navigation instructions to the starting location) after generating a transportation match with a provider computing device. Indeed, the recurring value lock generation system 102 can generate a request that utilizes a recurring value lock, a transportation match, and a transportation dispatch with a single user interface interaction.

As mentioned, in one or more embodiments, the recurring value lock generation system 102 provides a recurring value lock management interface for managing recurring value locks. In particular, the recurring value lock generation system 102 provides a recurring value lock management interface that can display information about recurring value locks and receive user input to generate or update recurring value locks. FIGS. 8A-8B illustrate example recurring value lock management interfaces for managing recurring value locks associated with a computing device in accordance with one or more embodiments.

As illustrated in FIG. 8A, in one or more embodiments, the recurring value lock generation system 102 provides element 802 for a recurring value lock and element 804 for an additional recurring value lock. For example, the recurring value lock generation system 102 provides element 802 and element 804, which provide details of the respective recurring value locks. Moreover, element 802 and element 804 are selectable options that, when selected, display additional information about the corresponding recurring value lock.

In addition, the recurring value lock generation system 102 can also display an option to generate an additional recurring value lock. Specifically, the recurring value lock generation system 102 provides a selectable option that generates an additional graphical user interface with a starting location element, a destination location element, and a recurring value lock time window element for generating an additional recurring value lock. Upon generating the additional recurring value lock, the recurring value lock generation system 102 will generate an additional element in the recurring value lock management interface for the additional recurring value lock.

As illustrated in FIG. 8B, in one or more embodiments, the recurring value lock generation system 102 provides additional details 806 for a recurring value lock based on detecting a user selection of an element 802 in a recurring value lock management interface. Specifically, the recurring value lock generation system 102 displays additional details 806 that are not provided in element 802. For example, the recurring value lock generation system 102 displays a coverage area, an indication of a marginal requester value (e.g., an amount saved), and terms for the recurring value lock.

In addition, the recurring value lock generation system 102 also provides options to manage a recurring value lock in a transportation value lock management interface. For example, as shown, the recurring value lock generation system 102 provides an option to cancel the recurring value lock (e.g., by providing a selectable cancellation option). As another example, as shown, the recurring value lock generation system 102 can provide an option to view coverage areas (e.g., that will provide a map indicating coverage areas when selected).

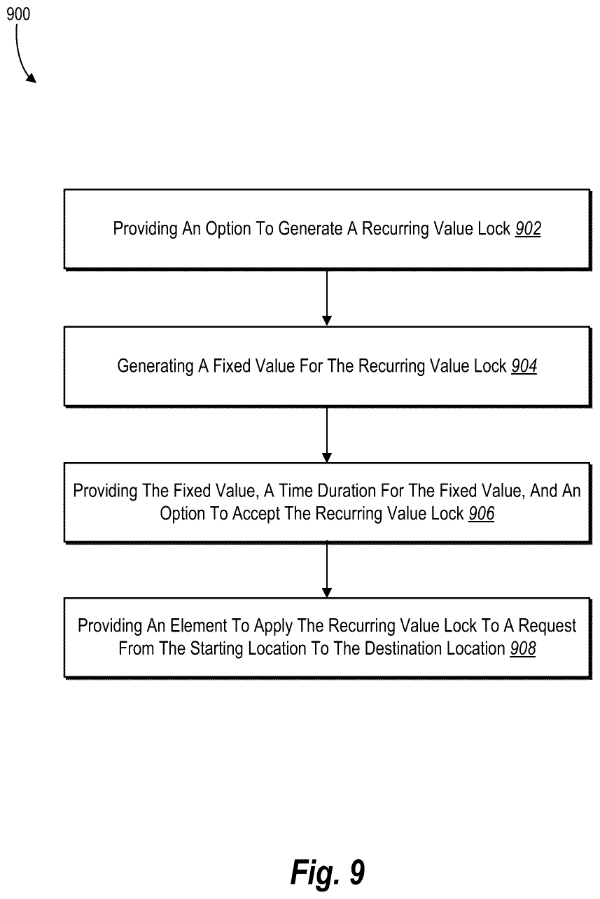

FIGS. 1-8B, the corresponding text, and the examples provide a number of different methods, systems, devices, and non-transitory computer-readable media of the recurring value lock generation system 102. In addition to the foregoing, one or more embodiments can also be described in terms of flowcharts comprising acts for accomplishing a particular result, as shown in FIG. 9. FIG. 9 may be performed with more or fewer acts. Further, the acts may be performed in differing orders. Additionally, the acts described herein may be repeated or performed in parallel with one another or parallel with different instances of the same or similar acts.

As mentioned, FIG. 9 illustrates a flowchart of a series of acts 900 for generating a recurring value lock in accordance with one or more embodiments. While FIG. 9 illustrates acts according to one embodiment, alternative embodiments may omit, add to, reorder, and/or modify any of the acts shown in FIG. 9. The acts of FIG. 9 can be performed as part of a method. Alternatively, a non-transitory computer-readable medium can comprise instructions that, when executed by one or more processors, cause a computing device to perform the acts of FIG. 9. In some embodiments, a system can perform the acts of FIG. 9.

As shown in FIG. 9, the series of acts 900 includes an act 902 of providing an option to generate a recurring value lock, an act 904 of generating a fixed value for the recurring value lock, an act 906 of providing the fixed value, a time duration for the fixed value, and an option to accept the recurring value lock and an act 908 of providing an element to apply the recurring value lock to a request from the starting location to the destination location.

In particular, the act 902 can include providing, for display within a graphical user interface of a computing device, an option to generate a recurring value lock by providing a starting location element, a destination location element, and a recurring window element, the act 904 can include based on receiving, via one or more server devices, a user interaction with the starting location element, the destination location element, and the recurring window element, generating a fixed value for the recurring value lock, the act 906 can include providing, for display within the graphical user interface on the computing device, the fixed value for the recurring value lock, a recurring window for the recurring value lock, a time duration for the fixed value, and an option to accept the recurring value lock, and the act 908 can include in response to receiving, via the one or more server devices, a user interaction with the option to accept the recurring value lock and upon receiving, via the one or more server devices, an indication of a user interaction with an application of the computing device during the recurring window and within the time duration, providing, for display within the graphical user interface on the computing device, an element to apply the recurring value lock to a request from a starting location of the recurring value lock to a destination location of the recurring value lock.

For example, in one or more embodiments, the series of acts 900 includes further comprising providing, for display within the graphical user interface on the computing device and with the fixed value for the recurring value lock, the time duration for the fixed value, and the option to accept the recurring value lock, a notification of an upfront value for generating the recurring value lock.

In addition, in one or more embodiments, the series of acts 900 wherein providing the option to generate the recurring value lock further comprises monitoring requests and requester features from the computing device to determine a recurring pattern and providing, within the graphical user interface on the computing device, the option to generate the recurring value lock based on the recurring pattern of the computing device.

Also, in one or more embodiments, the series of acts 900 includes providing, for display within a recurring value lock management user interface on the computing device: an indication of the recurring value lock and the fixed value for the recurring value lock, an additional indication of an additional recurring value lock associated with the computing device and an additional fixed value for the additional recurring value lock, and one or more selectable elements to manage the recurring value lock or the additional recurring value lock.

Further, in one or more embodiments, the series of acts 900 wherein generating the fixed value for the recurring value lock further comprises utilizing a forecasting model to generate the fixed value for the recurring value lock based on historical values corresponding to location-time combinations corresponding to the starting location, the destination location, and the recurring window.

Additionally, in one or more embodiments, the series of acts 900 includes determining, based on monitoring requests from the computing device applying the recurring value lock, that a marginal value of the recurring value lock satisfies a value threshold, and providing, for display within the graphical user interface on the computing device, a notification that the computing device satisfies the value threshold and a notification that the recurring value lock is no longer active.

Moreover, in one or more embodiments, the series of acts 900 includes providing, for display in the graphical user interface on the computing device, an additional element for initiating an additional request from the starting location to the destination location and a notification of an additional value for the additional request.

In addition, in one or more embodiments, the series of acts 900 wherein providing the element to apply the recurring value lock to the request further comprises receiving, via the one or more server devices and from the computing device, a user input of the starting location in the starting location element and the destination location in the destination location element, determining that a time corresponding to the user input of the starting location and the destination location corresponds to the recurring window, and based on determining that the time corresponding to the user input of the starting location and the destination location satisfies the recurring window, providing, for display, the element to apply the recurring value lock to the request by providing, within the graphical user interface on the computing device, a request element to initiate the request from the starting location to the destination location and a notification that the request utilizes the fixed value.

Additionally, in one or more embodiments, the series of acts 900 wherein providing the element to apply the recurring value lock to a request further comprises identifying initiation of an application session via the computing device, determining that a current location for the computing device corresponds to the starting location for the recurring value lock and that a current time is within the recurring window, and based identifying initiation of the application session via the computing device and determining that the current location for the computing device corresponds to the starting location and that the current time is within the recurring window, providing, for display within the graphical user interface on the computing device, a selectable option to generate the request applying the recurring value lock.

Moreover, in one or more embodiments, the series of acts 900 includes receiving, via the one or more server devices and from the computing device, a user selection of the selectable option to generate the request applying the recurring value lock, and generating a match with an additional computing device in response to receiving the user selection of the selectable option to generate the request applying the recurring value lock.

Also, in one or more embodiments, the series of acts 900 includes providing, for display within the graphical user interface of the computing device and with the fixed value for the recurring value lock, the time duration for the fixed value, and the option to accept the recurring value lock, a notification of an upfront value for generating the recurring value lock.

Further, in one or more embodiments, the series of acts 900 includes providing, for display within a recurring value lock management interface on the computing device: an indication of the recurring value lock and the fixed value for the recurring value lock, an additional indication of an additional recurring value lock associated with the computing device and an additional fixed value for the additional recurring value lock, and one or more selectable options to manage the recurring value lock or the additional recurring value lock.

Additionally, in one or more embodiments, the series of acts 900 includes providing the option to generate the recurring value lock by: monitoring requests and requester features from the computing device to determine a recurring pattern, and providing the option to generate the recurring value lock based on the recurring pattern of the computing device.

In addition, in one or more embodiments, the series of acts 900 includes generating the fixed value for the recurring value lock based on historical values corresponding to location-time combinations corresponding to the starting location, the destination location, and the recurring window.

Moreover, in one or more embodiments, the series of acts 900 includes determining, based on monitoring requests from the computing device applying the recurring value lock, that a marginal value of the recurring value lock satisfies a value threshold, and providing, for display within the graphical user interface on the computing device, a notification that the computing device satisfies the value threshold and a notification that the recurring value lock is no longer active.

Also, in one or more embodiments, the series of acts 900 includes providing, for display in the graphical user interface on the computing device, an additional element for initiating an additional request from the starting location to the destination location and a notification of an additional value for the additional request.

Moreover, in one or more embodiments, the series of acts 900 includes provide the element to apply the recurring value lock to the request by: receiving, from the computing device, a user input of the starting location in the starting location element and the destination location in the destination location element, determining that a time corresponding to the user input of the starting location and the destination location corresponds to the recurring window, and based on determining that the time corresponding to the user input of the starting location and the destination location satisfies the recurring window, providing, for display within the graphical user interface on the computing device, the element to apply the recurring value lock to the request by providing a request element to initiate the request from the starting location to the destination location and a notification that the request utilizes the fixed value.

Further, in one or more embodiments, the series of acts 900 includes identifying initiation of an application session via the computing device, determine that a current location for the computing device corresponds to the starting location for the recurring value lock and that a current time is within the recurring window, and based identifying initiation of the application session via the computing device and determining that the current location for the computing device corresponds to the starting location and that the current time is within the recurring window, provide, for display within the graphical user interface on the computing device, a selectable option to generate the request applying the recurring value lock.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 10 illustrates a block diagram of an example computing device 1000 that may be configured to perform one or more of the processes described above. One will appreciate that one or more computing devices, such as the computing device 1000 may represent the computing devices described above (e.g., server device(s) 106, computing device 108, or computing device 112). In one or more embodiments, the computing device 1000 may be a mobile device (e.g., a mobile telephone, a smartphone, a PDA, a tablet, a laptop, a camera, a tracker, a watch, a wearable device, etc.). In some embodiments, the computing device 1000 may be a non-mobile device (e.g., a desktop computer or another type of client device). Further, the computing device 1000 may be a server device that includes cloud-based processing and storage capabilities.

As shown in FIG. 10, the computing device 1000 can include one or more processor(s) 1002, memory 1004, a storage device 1006, input/output interfaces 1008 (or “I/O interfaces 1008”), and a communication interface 1010, which may be communicatively coupled by way of a communication infrastructure (e.g., bus 1012). While the computing device 1000 is shown in FIG. 10, the components illustrated in FIG. 10 are not intended to be limiting. Additional or alternative components may be used in other embodiments. Furthermore, in certain embodiments, the computing device 1000 includes fewer components than those shown in FIG. 10. Components of the computing device 1000 shown in FIG. 10 will now be described in additional detail.

In particular embodiments, the processor(s) 1002 includes hardware for executing instructions, such as those making up a computer program. As an example, and not by way of limitation, to execute instructions, the processor(s) 1002 may retrieve (or fetch) the instructions from an internal register, an internal cache, memory 1004, or a storage device 1006 and decode and execute them.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1004 may be internal or distributed memory.

The computing device 1000 includes a storage device 1006 includes storage for storing data or instructions. As an example, and not by way of limitation, the storage device 1006 can include a non-transitory storage medium described above. The storage device 1006 may include a hard disk drive (HDD), flash memory, a Universal Serial Bus (USB) drive or a combination these or other storage devices.

As shown, the computing device 1000 includes one or more I/O interfaces 1008, which are provided to allow a user to provide input to (such as user strokes), receive output from, and otherwise transfer data to and from the computing device 1000. These I/O interfaces 1008 may include a mouse, keypad or a keyboard, a touch screen, camera, optical scanner, network interface, modem, other known I/O devices or a combination of such I/O interfaces 1008. The touch screen may be activated with a stylus or a finger.

The I/O interfaces 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1008 are configured to provide graphical data to a display for presentation to a user. The graphical data may be representative of one or more graphical user interfaces and/or any other graphical content as may serve a particular implementation.

The computing device 1000 can further include a communication interface 1010. The communication interface 1010 can include hardware, software, or both. The communication interface 1010 provides one or more interfaces for communication (such as, for example, packet-based communication) between the computing device and one or more other computing devices or one or more networks. As an example, and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI. The computing device 1000 can further include a bus 1012. The bus 1012 can include hardware, software, or both that connects components of computing device 1000 to each other.

FIG. 11 illustrates an example network environment 1100 of the transportation matching system 104. The network environment 1100 includes a client device 1106 (e.g., the computing device 112 or the computing device 108), a transportation matching system 104, and a vehicle subsystem 1108 connected to each other by a network 1104. Although FIG. 11 illustrates a particular arrangement of the client device 1106, the transportation matching system 104, the vehicle subsystem 1108, and the network 1104, this disclosure contemplates any suitable arrangement of client device 1106, the transportation matching system 104, the vehicle subsystem 1108, and the network 1104. As an example, and not by way of limitation, two or more of client device 1106, the transportation matching system 104, and the vehicle subsystem 1108 communicate directly, bypassing network 1104. As another example, two or more of client device 1106, the transportation matching system 104, and the vehicle subsystem 1108 may be physically or logically co-located with each other in whole or in part.

Moreover, although FIG. 11 illustrates a particular number of client devices 1106, transportation matching system 104, vehicle subsystems 1108, and networks 1104, this disclosure contemplates any suitable number of client devices 1106, transportation matching system 104, vehicle subsystems 1108, and networks 1104. As an example, and not by way of limitation, network environment 1100 may include multiple client devices 1106, transportation matching system 104, vehicle subsystems 1108, and/or networks 1104.

This disclosure contemplates any suitable network 1104. As an example, and not by way of limitation, one or more portions of network 1104 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1104 may include one or more networks 1104.

Links may connect client device 1106, recurring value lock generation system 102, and vehicle subsystem 1108 to network 1104 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1100. One or more first links may differ in one or more respects from one or more second links.

In particular embodiments, the client device 1106 may be an electronic device including hardware, software, or embedded logic components or a combination of two or more such components and capable of carrying out the appropriate functionalities implemented or supported by client device 1106. As an example, and not by way of limitation, a client device 1106 may include any of the computing devices discussed above in relation to FIG. 10. A client device 1106 may enable a network user at the client device 1106 to access network 1104. A client device 1106 may enable its user to communicate with other users at other client devices 1106.

In particular embodiments, the client device 1106 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 1106 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1106 one or more Hyper Text Markup Language (“HTML”) files responsive to the HTTP request. The client device 1106 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, transportation matching system 104 may be a network-addressable computing system that can host a transportation matching network. The transportation matching system 104 may generate, store, receive, and send data, such as, for example, user-profile data, concept-profile data, text data, transportation request data, GPS location data, provider data, requester data, vehicle data, or other suitable data related to the transportation matching network. This may include authenticating the identity of providers and/or vehicles who are authorized to provide transportation services through the transportation matching system 104. In addition, the transportation matching system 104 may manage identities of service requesters such as users/requesters. In particular, the transportation matching system 104 may maintain requester data such as driving/riding histories, personal data, or other user data in addition to navigation and/or traffic management services or other location services (e.g., GPS services).

In particular embodiments, the transportation matching system 104 may manage transportation matching services to connect a user/requester with a vehicle and/or provider. By managing the transportation matching services, the transportation matching system 104 can manage the distribution and allocation of resources from vehicle systems and user resources such as GPS location and availability indicators, as described herein.

The transportation matching system 104 may be accessed by the other components of network environment 1100 either directly or via network 1104. In particular embodiments, the transportation matching system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the transportation matching system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1106, or a transportation matching system 104 to manage, retrieve, modify, add, or delete, the information stored in data store.

In particular embodiments, the transportation matching system 104 may provide users with the ability to take actions on various types of items or objects, supported by the transportation matching system 104. As an example, and not by way of limitation, the items and objects may include transportation matching networks to which users of the transportation matching system 104 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in the transportation matching system 104 or by an external system of a third-party system, which is separate from transportation matching system 104 and coupled to the transportation matching system 104 via a network 1104.

In particular embodiments, the transportation matching system 104 may be capable of linking a variety of entities. As an example, and not by way of limitation, the transportation matching system 104 may enable users to interact with each other or other entities, or to allow users to interact with these entities through an application programming interfaces (“API”) or other communication channels.

In particular embodiments, the transportation matching system 104 may include a variety of servers, sub-systems, programs, modules, logs, and data stores. In particular embodiments, the transportation matching system 104 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile (e.g., provider profile or requester profile) store, connection store, third-party content store, or location store. The transportation matching system 104 may also include suitable components such as network interfaces, security mechanisms, load balancers, failover servers, management-and-network-operations consoles, other suitable components, or any suitable combination thereof. In particular embodiments, the transportation matching system 104 may include one or more user-profile stores for storing user profiles for transportation providers and/or transportation requesters. A user profile may include, for example, biographic information, demographic information, behavioral information, social information, or other types of descriptive information, such as interests, affinities, or location.

The web server may include a mail server or other messaging functionality for receiving and routing messages between the transportation matching system 104 and one or more client devices 1106. An action logger may be used to receive communications from a web server about a user's actions on or off the transportation matching system 104. In conjunction with the action log, a third-party-content-object log may be maintained of user exposures to third-party-content objects. A notification controller may provide information regarding content objects to a client device 1106. Information may be pushed to a client device 1106 as notifications, or information may be pulled from client device 1106 responsive to a request received from client device 1106. Authorization servers may be used to enforce one or more privacy settings of the users of the transportation matching system 104. A privacy setting of a user determines how particular information associated with a user can be shared. The authorization server may allow users to opt in to or opt out of having their actions logged by the transportation matching system 104 or shared with other systems, such as, for example, by setting appropriate privacy settings. Third-party-content-object stores may be used to store content objects received from third parties. Location stores may be used for storing location information received from client devices 1106 associated with users.

In addition, the vehicle subsystem 1108 can include a human-operated vehicle or an autonomous vehicle. A provider of a human-operated vehicle can perform maneuvers to pick up, transport, and drop off one or more requesters according to the embodiments described herein. In certain embodiments, the vehicle subsystem 1108 can include an autonomous vehicle—e.g., a vehicle that does not require a human operator. In these embodiments, the vehicle subsystem 1108 can perform maneuvers, communicate, and otherwise function without the aid of a human provider, in accordance with available technology.

In particular embodiments, the vehicle subsystem 1108 may include one or more sensors incorporated therein or associated thereto. For example, sensor(s) can be mounted on the top of the vehicle subsystem 1108 or else can be located within the interior of the vehicle subsystem 1108. In certain embodiments, the sensor(s) can be located in multiple areas at once—e.g., split up throughout the vehicle subsystem 1108 so that different components of the sensor(s) can be placed in different locations in accordance with optimal operation of the sensor(s). In these embodiments, the sensor(s) can include motion-related components such as an inertial measurement unit (“IMU”) including one or more accelerometers, one or more gyroscopes, and one or more magnetometers. The sensor(s) can additionally or alternatively include a wireless IMU (“WIMU”), one or more cameras, one or more microphones, or other sensors or data input devices capable of receiving and/or recording information relating to navigating a route to pick up, transport, and/or drop off a requester.

In particular embodiments, the vehicle subsystem 1108 may include a communication device capable of communicating with the client device 1106 and/or the recurring value lock generation system 102. For example, the vehicle subsystem 1108 can include an on-board computing device communicatively linked to the network 1104 to transmit and receive data such as GPS location information, sensor-related information, requester location information, or other relevant information.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
providing, for display within a graphical user interface of a computing device, an option to generate a recurring value lock by providing a starting location element, a destination location element, and a recurring window element;
based on receiving, via one or more server devices, a user interaction with the starting location element, the destination location element, and the recurring window element, generating a fixed value for the recurring value lock;
providing, for display within the graphical user interface on the computing device, the fixed value for the recurring value lock, a recurring window for the recurring value lock, a time duration for the fixed value, and an option to accept the recurring value lock; and
in response to receiving, via the one or more server devices, a user interaction with the option to accept the recurring value lock and upon receiving, via the one or more server devices, an indication of a user interaction with an application of the computing device during the recurring window and within the time duration, providing, for display within the graphical user interface on the computing device, an element to apply the recurring value lock to a request from a starting location of the recurring value lock to a destination location of the recurring value lock.

2. The computer-implemented method of claim 1, further comprising providing, for display within the graphical user interface on the computing device and with the fixed value for the recurring value lock, the time duration for the fixed value, and the option to accept the recurring value lock, a notification of an upfront value for generating the recurring value lock.

3. The computer-implemented method of claim 1, wherein providing the option to generate the recurring value lock further comprises:
monitoring requests and requester features from the computing device to determine a recurring pattern; and
providing, within the graphical user interface on the computing device, the option to generate the recurring value lock based on the recurring pattern of the computing device.

4. The computer-implemented method of claim 1, further comprising providing, for display within a recurring value lock management user interface on the computing device:
an indication of the recurring value lock and the fixed value for the recurring value lock;
an additional indication of an additional recurring value lock associated with the computing device and an additional fixed value for the additional recurring value lock; and
one or more selectable elements to manage the recurring value lock or the additional recurring value lock.

5. The computer-implemented method of claim 1, wherein generating the fixed value for the recurring value lock further comprises utilizing a forecasting model to generate the fixed value for the recurring value lock based on historical values corresponding to location-time combinations corresponding to the starting location, the destination location, and the recurring window.

6. The computer-implemented method of claim 1, further comprising:
determining, based on monitoring requests from the computing device applying the recurring value lock, that a marginal value of the recurring value lock satisfies a value threshold; and
providing, for display within the graphical user interface on the computing device, a notification that the computing device satisfies the value threshold and a notification that the recurring value lock is no longer active.

7. The computer-implemented method of claim 1, further comprising providing, for display in the graphical user interface on the computing device, an additional element for initiating an additional request from the starting location to the destination location and a notification of an additional value for the additional request.

8. The computer-implemented method of claim 1, wherein providing the element to apply the recurring value lock to the request further comprises:
receiving, via the one or more server devices and from the computing device, a user input of the starting location in the starting location element and the destination location in the destination location element;
determining that a time corresponding to the user input of the starting location and the destination location corresponds to the recurring window; and
based on determining that the time corresponding to the user input of the starting location and the destination location satisfies the recurring window, providing, for display, the element to apply the recurring value lock to the request by providing, within the graphical user interface on the computing device, a request element to initiate the request from the starting location to the destination location and a notification that the request utilizes the fixed value.

9. The computer-implemented method of claim 1, wherein providing the element to apply the recurring value lock to a request further comprises:
identifying initiation of an application session via the computing device;
determining that a current location for the computing device corresponds to the starting location for the recurring value lock and that a current time is within the recurring window; and
based identifying initiation of the application session via the computing device and determining that the current location for the computing device corresponds to the starting location and that the current time is within the recurring window, providing, for display within the graphical user interface on the computing device, a selectable option to generate the request applying the recurring value lock.

10. The computer-implemented method of claim 9, further comprising:
receiving, via the one or more server devices and from the computing device, a user selection of the selectable option to generate the request applying the recurring value lock; and
generating a match with an additional computing device in response to receiving the user selection of the selectable option to generate the request applying the recurring value lock.

11. A non-transitory computer-readable medium storing instructions that, when executed by at least one processor, cause a computer system to:
provide, for display within a graphical user interface of a computing device, an option to generate a recurring value lock by providing a starting location element, a destination location element, and a recurring window element;
based on receiving, via one or more server devices, a user interaction with the starting location element, the destination location element, and the recurring window element, generate a fixed value for the recurring value lock;
provide, for display within the graphical user interface on the computing device, the fixed value for the recurring value lock, a recurring window for the recurring value lock, a time duration for the fixed value, and an option to accept the recurring value lock; and
in response to receiving, via the one or more server devices, a user interaction with the option to accept the recurring value lock and upon receiving, via the one or more server devices, an indication of a user interaction with an application of the computing device during the recurring window and within the time duration, provide, for display within the graphical user interface on the computing device, an element to apply the recurring value lock to a request from a starting location of the recurring value lock to a destination location of the recurring value lock.

12. The non-transitory computer-readable medium of claim 11, further comprising instructions that, when executed by the at least one processor, cause the computer system to provide, for display within the graphical user interface of the computing device and with the fixed value for the recurring value lock, the time duration for the fixed value, and the option to accept the recurring value lock, a notification of an upfront value for generating the recurring value lock.

13. The non-transitory computer-readable medium of claim 11, further comprising instructions that, when executed by the at least one processor, cause the computer system to provide, for display within a recurring value lock management interface on the computing device:
an indication of the recurring value lock and the fixed value for the recurring value lock;
an additional indication of an additional recurring value lock associated with the computing device and an additional fixed value for the additional recurring value lock; and
one or more selectable options to manage the recurring value lock or the additional recurring value lock.

14. The non-transitory computer-readable medium of claim 11, further comprising instructions that, when executed by the at least one processor, cause the computer system to provide the option to generate the recurring value lock by:
monitoring requests and requester features from the computing device to determine a recurring pattern; and
providing the option to generate the recurring value lock based on the recurring pattern of the computing device.

15. The non-transitory computer-readable medium of claim 11, further comprising instructions that, when executed by the at least one processor, cause the computer system to generate the fixed value for the recurring value lock based on historical values corresponding to location-time combinations corresponding to the starting location, the destination location, and the recurring window.

16. A system comprising:
at least one processor; and
at least one non-transitory computer-readable storage medium storing instructions that, when executed by the at least one processor, cause the system to:
provide, for display within a graphical user interface of a computing device, an option to generate a recurring value lock by providing a starting location element, a destination location element, and a recurring window element;
based on receiving, via one or more server devices, a user interaction with the starting location element, the destination location element, and the recurring window element, generate a fixed value for the recurring value lock;
provide, for display within the graphical user interface on the computing device, the fixed value for the recurring value lock, a recurring window for the recurring value lock, a time duration for the fixed value, and an option to accept the recurring value lock; and
in response to user interaction with the option to accept the recurring value lock and upon receiving, via the one or more server devices, an indication of a user interaction with an application of the computing device during the recurring window and within the time duration, provide, for display within the graphical user interface on the computing device, an element to apply the recurring value lock to a request from a starting location of the recurring value lock to a destination location of the recurring value lock.

17. The system of claim 16, further comprising instructions that, when executed by the at least one processor, cause the system to:
determine, based on monitoring requests from the computing device applying the recurring value lock, that a marginal value of the recurring value lock satisfies a value threshold; and
providing, for display within the graphical user interface on the computing device, a notification that the computing device satisfies the value threshold and a notification that the recurring value lock is no longer active.

18. The system of claim 16, further comprising instructions that, when executed by the at least one processor, cause the system to provide, for display in the graphical user interface on the computing device, an additional element for initiating an additional request from the starting location to the destination location and a notification of an additional value for the additional request.

19. The system of claim 16, further comprising instructions that, when executed by the at least one processor, cause the system to provide the element to apply the recurring value lock to the request by:
receiving, from the computing device, a user input of the starting location in the starting location element and the destination location in the destination location element;
determining that a time corresponding to the user input of the starting location and the destination location corresponds to the recurring window; and
based on determining that the time corresponding to the user input of the starting location and the destination location satisfies the recurring window, providing, for display within the graphical user interface on the computing device, the element to apply the recurring value lock to the request by providing a request element to initiate the request from the starting location to the destination location and a notification that the request utilizes the fixed value.

20. The system of claim 16, further comprising instructions that, when executed by the at least one processor, cause the system to:
identify initiation of an application session via the computing device;
determine that a current location for the computing device corresponds to the starting location for the recurring value lock and that a current time is within the recurring window; and
based identifying initiation of the application session via the computing device and determining that the current location for the computing device corresponds to the starting location and that the current time is within the recurring window, provide, for display within the graphical user interface on the computing device, a selectable option to generate the request applying the recurring value lock.
